(19) United States
(12) Patent Application Publication
(10) Pub. No.: US 2026/0316314 A1
(43) Pub. Date: Oct. 15, 2026

(54) TIRE CUTTING DEVICE, TIRE CUTTING METHOD, AND TIRE ADJUSTMENT DEVICE FOR MOTOR SPORTS

(71) Applicant: Kanesuzu Precision Co., Ltd., Ome (JP)

(72) Inventor: Takayuki SUZUKI, Ome (JP)

(21) Appl. No.: 19/164,800

(22) PCT Filed: Mar. 4, 2024
(86) PCT No.: PCT/JP2024/007928

§ 371 Date: Jul. 2, 2026

(30) Foreign Application Priority Data
Mar. 14, 2023 (JP) 2023-039362
Mar. 16, 2023 (JP) 2023-042205

(51) Int. Cl. B26D 3/00

(52) U.S. Cl. CPC B26D 3/005

(57) ABSTRACT

There are provided a tire shaving device, a tire shaving method, and a motor sport tire adjustment device that can form, on a tread portion of a tire, a traveling surface for improving ground contact and can form, on the tire, a traveling surface having a shape close to a circle of a predetermined diameter while suppressing thermal deterioration of the surface of the tire during shaving. The tire shaving device according to the present invention includes: a blade configured to shave the surface of the tire; a blade attachment portion to which the blade is attached; a blade rotation driving unit configured to rotate the blade attachment portion; a tire holding unit configured to hold the tire; a tire rotation driving unit configured to rotate the tire in a state where the tire is held; and a positioning unit configured to be able to position the blade at a predetermined distance from a center axis of the tire. The tire shaving device shaves the surface of the tire to form a traveling surface of the tire at the predetermined distance from the center axis of the tire while suppressing thermal deterioration of the surface of the tire during shaving.

### TECHNICAL FIELD

The present invention relates to a tire shaving device, a tire shaving method, and a motor sport tire adjustment device, and in particular to a tire shaving device, a tire shaving method, and a motor sport tire adjustment device for shaving a surface of a tire.

### BACKGROUND ART

As disclosed in Patent Literature 1 (Japanese Patent Laid-Open No. 2007-196347), there is known an automobile tire surface polishing device that polishes a surface of a tire while a polishing position and a polishing amount are visually recognized, in order to retrieve gripping force from a lowered state.

### SUMMARY OF INVENTION

### Technical Problem

However, the automobile tire surface polishing device as disclosed in Patent Literature 1 has an issue that when the device polishes the surface of the tire, heat is generated due to polishing, which causes thermal deterioration on the surface of the tire in polishing.

There is a case where it is desired to use the tire under a situation that performance of the tire is desirably brought out to the utmost limit, like time trial traveling, a race, and the like in a circuit. Under such a situation of the time trial traveling and the like, a winner is determined by reducing the time by, for example, 0.1 seconds, or for example, even by 0.01 seconds to achieve a faster time. Therefore, utmost tire performance that far exceeds tire performance satisfying a condition for public road traveling and brings out potential of a motor sport tire close to a limit is required.

On the other hand, there is a case where a thermally-deteriorated portion generated by heat cycle after circuit traveling is generated on the surface of the tire, and the original traveling performance of the tire cannot be brought out. In this regard, the inventor has newly found that, even when the automobile tire surface polishing device as disclosed in Patent Literature 1 polishes the thermally-deteriorated portion of the surface of the tire, heat is generated due to polishing when the surface of the tire is polished, and accordingly, an issue arises that deterioration caused by heating is further generated on the surface of the tire in polishing.

The present invention is made to solve such issues, and provides a tire shaving device and a tire shaving method that can form, on a tread portion of the tire, a traveling surface for improving ground contact and can form, on the tire, the traveling surface having a shape close to a circle of a predetermined diameter while suppressing thermal deterioration of the surface of the tire during shaving.

Further, the present invention is made to solve such issues, and provides a motor sport tire adjustment device and a motor sport tire adjustment method that can actively adjust shapes of a tread portion and a shoulder portion of a motor sport tire to shapes having desired traveling characteristics while suppressing thermal deterioration in a case where a shape of the surface of the tire is adjusted.

### Solution to Problem

To achieve the above-described objects, according to an embodiment of the present invention, a tire shaving device for shaving a surface of a tire includes: a blade configured to shave the surface of the tire; a blade attachment portion to which the blade is attached; a blade rotation driving unit configured to rotate the blade attachment portion; a tire holding unit configured to hold the tire; a tire rotation driving unit configured to rotate the tire in a state where the tire is held; and a positioning unit configured to be able to position the blade at a predetermined distance from a center axis of the tire. The tire shaving device shaves the surface of the tire to form a traveling surface of the tire at the predetermined distance from the center axis of the tire while suppressing thermal deterioration of the surface of the tire during shaving.

According to the embodiment of the present invention configured as described above, by shaving the surface of the tire, the traveling surface of the tire can be formed at the predetermined distance from the center axis of the tire while thermal deterioration of the surface of the tire during shaving is suppressed. As a result, the traveling surface for improving ground contact can be formed on the tread portion of the tire, and the traveling surface having a shape close to a circle of a predetermined diameter can be formed on the tire while thermal deterioration of the surface of the tire during shaving is suppressed. Therefore, the traveling surface of the tire that can easily bring out the traveling performance of the tire to the utmost limit can be formed. Accordingly, to reduce the time by 0.1 seconds or the like, the original traveling performance of the tire can be easily brought out to the utmost limit in the tire used for time trial and the like in the circuit.

According to an embodiment of the present invention, preferably, a tire shaving method of shaving a surface of a tire includes: a blade rotation step of rotating a blade attachment portion to which a blade is attached; a tire rotation step of rotating the tire in a state where the tire is held; a positioning step of positioning the blade at a predetermined distance from a center axis of the tire; and a tire shaving step of shaving the surface of the tire to form a traveling surface of the tire at the predetermined distance from the center axis of the tire while suppressing thermal deterioration of the surface of the tire during shaving.

According to the embodiment of the present invention configured as described above, by shaving the surface of the tire, the traveling surface of the tire can be formed at the predetermined distance from the center axis of the tire while thermal deterioration of the surface of the tire during shaving is suppressed. As a result, the traveling surface for improving ground contact can be formed on the tread portion of the tire, and the traveling surface having a shape close to a circle of a predetermined diameter can be formed on the tire while thermal deterioration of the surface of the tire during shaving is suppressed. Therefore, the traveling surface of the tire that can easily bring out the traveling performance of the tire to the utmost limit can be formed. Accordingly, to reduce the time by 0.1 seconds or the like, the original traveling performance of the tire can be easily brought out to the utmost limit in the tire used for time trial and the like in the circuit.

To achieve the above-described objects, according to an embodiment of the present invention, a motor sport tire adjustment device for adjusting a motor sport tire includes: a blade configured to shave a surface of the tire; a blade attachment portion to which the blade is attached; a blade rotation driving unit configured to rotate the blade attachment portion; a tire holding unit configured to hold the tire; a tire rotation driving unit configured to rotate the tire in a state where the tire is held; a first adjustment mechanism configured to be able to move the blade in a first direction toward the tire; a second adjustment mechanism configured to be able to move the blade in a second direction orthogonal to the first direction; and a blade angle adjustment mechanism configured to be able to adjust inclination of the blade between the first direction and the second direction. The blade is adjusted in inclination by the blade angle adjustment mechanism and is positioned by the first adjustment mechanism and the second adjustment mechanism, and the blade shaves the surface of the tire in an intended shape and adjusts the motor sport tire to a shape having desired traveling characteristics.

According to the embodiment of the present invention configured as described above, the blade is adjusted in inclination by the blade angle adjustment mechanism and is positioned by the first adjustment mechanism and the second adjustment mechanism, and the blade can shave the surface of the tire in the intended shape and can adjust the motor sport tire to the shape having the desired traveling characteristics. As a result, the motor sport tire can be adjusted to have the desired traveling characteristics while thermal deterioration in the case where the shape of the surface of the tire is adjusted is suppressed. For example, the tread portion of the tire can be adjusted to form the linear portion parallel to the axial direction of the tire, and for example, the ground-contact surface of the tread portion of the tire can be increased. Further, for example, a part of the tread portion of the tire can be adjusted to form the linear portion of the angle slightly inclined from the axial direction of the tire, and for example, the linear portion corresponding to the camber angle can be formed on the tread portion. Therefore, by shaving the surface of the tire, it is possible to adjust the shape of the tire so as to exert the desired traveling characteristics of the tire at an extremely high level while suppressing thermal deterioration of the tire during shaving. Further, for example, the shape of the tire can be relatively easily and freely deformed. Thus, a driver and a team can try by changing the traveling characteristics of the tire, and can easily reach better setting for bringing out the original performance of the tire to the utmost limit based on characteristics and a condition of the driver. Therefore, for example, according to the embodiment of the present invention, by shaving the surface of the tire, it is possible to actively change and adjust the shapes of the tread portion and the shoulder portion of the tire, and to perform setting or adjustment of the tire including change of the shape of the motor sport tire.

### ADVANTAGEOUS EFFECTS OF INVENTION

According to the tire shaving device, the tire shaving method, and the motor-sport tire adjustment device of the present invention, it is possible to form, on the tread portion of the tire, the traveling surface for improving ground contact and to form, on the tire, the traveling surface having a shape close to a circle of a predetermined diameter while suppressing thermal deterioration of the surface of the tire during shaving.

### BRIEF DESCRIPTION OF DRAWINGS

FIG. 1 is an appearance perspective view of a tire shaving device according to a first embodiment of the present invention;

FIG. 2 is an appearance perspective view of the tire shaving device according to the first embodiment of the present invention;

FIG. 3 is a top view of the tire shaving device according to the first embodiment of the present invention;

FIG. 4 is a partial side view of the tire shaving device according to the first embodiment of the present invention;

FIG. 5 is an exploded perspective view of the tire shaving device according to the first embodiment of the present invention, the exploded perspective view illustrating a blade, a blade attachment portion, and the like on one side in a state where the blade attachment portion and the blade are disassembled;

FIG. 6 is a cross-sectional view of the blade attachment portion and the blade of the tire shaving device according to the first embodiment of the present invention;

FIG. 7 is a partial enlarged side view of the blade attachment portion and the blade in a state immediately before the blade of the tire shaving device according to the first embodiment of the present invention abuts on a tire to shave the tire;

FIG. 8 is a partial enlarged cross-sectional view illustrating, in an enlarged manner, a part of a cross-section of a tire shaved by the tire shaving device according to the first embodiment of the present invention;

FIG. 9 is a diagram illustrating steps of a tire shaving method according to the first embodiment of the present invention;

FIG. 10 is a diagram illustrating steps of a motor sport tire adjustment method according to a second embodiment of the present invention;

FIG. 11 is a partial enlarged cross-sectional view illustrating, in an enlarged manner, a part of a cross-section of a tire in a state where a tread portion of the tire is shaved by a motor sport tire adjustment device according to the second embodiment of the present invention and a tread portion shaved surface parallel to a center axis is formed;

FIG. 12 is a partial enlarged cross-sectional view illustrating, in an enlarged manner, a part of a cross-section of a tire in a state where a shoulder portion of the tire is shaved by the motor sport tire adjustment device according to the second embodiment of the present invention, and a shoulder portion shaved surface is formed;

FIG. 13 is a partial enlarged cross-sectional view illustrating, in an enlarged manner, a part of a cross-section of a tire in a state where a tread portion of the tire is shaved by the motor sport tire adjustment device according to the second embodiment of the present invention, and a tread portion inclined shaved surface is formed on the tread portion; and

FIG. 14 is a partial enlarged cross-sectional view illustrating, in an enlarged manner, a part of a cross-section of a tire in a state where a shoulder portion of the tire is shaved by the motor sport tire adjustment device according to the second embodiment of the present invention, and a first shoulder portion shaved surface and a second shoulder portion shaved surface are formed.

### DESCRIPTION OF EMBODIMENTS

A tire shaving device according to a first embodiment of the present invention is described below with reference to accompanying drawings.

In the following description of the first embodiment of the present invention, a front side when a tire is viewed from a blade side and a blade attachment portion side is defined as a front side, a tire side (depth side) is defined as a depth side, a right side when the tire is viewed from the blade side and the blade attachment portion side is defined as a right side, and a left side when the tire is viewed in a similar manner is defined as a left side.

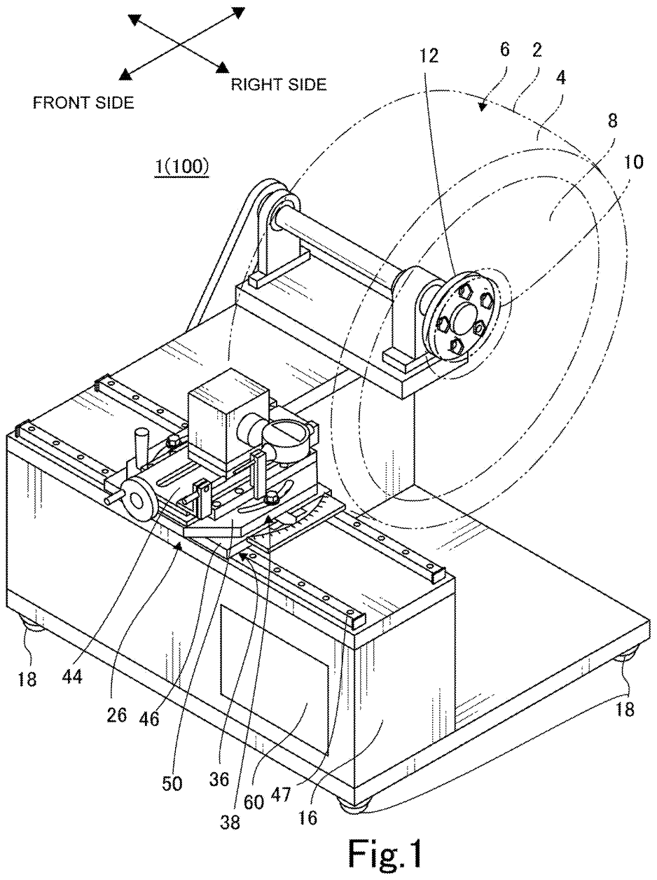

As illustrated in FIG. 1, a tire shaving device 1 according to the first embodiment of the present invention is a device for shaving a surface of a tire 2. The tire shaving device 1 performs cutting to shave the surface of the tire 2 by a blade described below. A motor sport tire adjustment device 1 performs adjustment by performing cutting to shave the surface of the tire 2. The tire shaving device 1 also functions as the motor sport tire adjustment device for adjusting a motor sport tire.

The tire 2 is a tire for traveling of an automobile. The tire 2 includes an outer peripheral portion 6 including a tread portion 4 and a shoulder portion 5, a wheel portion 8 supporting the outer peripheral portion 6, and a tire-side attachment portion 10 (bolt attachment portion) provided in the wheel portion 8. The outer peripheral portion 6 includes the tread portion 4 that mainly comes into contact with a road surface. The tread portion 4 and the shoulder portion 5 are mainly made of a rubber, for example, a synthetic rubber. The tread portion 4 and the shoulder portion 5 may be made of a synthetic resin or the like. The tire 2 is a tire for a four-wheeled vehicle, but is applicable to a tire for a two-wheeled vehicle.

The tire 2 is a sport tire and is, for example, a so-called high grip-type radial tire. For example, the tire 2 is a semi-racing tire, a semi-slick tire, a slick tire, a high grip tire, or the like used for a motor sport such as time trial traveling and race traveling in a circuit. The tire is a tire used under a situation that the automobile travels by bringing out performance of the automobile and traveling performance of the tire close to a limit, for example, in time trial traveling, race traveling, and the like in a circuit. Therefore, the tire 2 is directed to a motor sport tire of a type different from a so-called comfort tire and a so-called studless tire. The tire 2 has, for example, a diameter in a range from 590 mm to 720 mm. The tire 2 has, for example, a width in a range from 150 mm to 340 mm and also, for example, a width in a range from 220 mm to 310 mm.

The tire 2 according to the present embodiment is a sport tire or the like, and the present technique forms a traveling surface for bringing out traveling performance of the sport tire while suppressing thermal deterioration described below. Further, the present technique adjusts the tire 2 in a shape having desired traveling characteristics. Therefore, the present technique is a technique different from a technique for shaving a tread rubber of a so-called recapped tire (retreaded tire) to form a bonding surface to be bonded with a fresh tread.

The tire-side attachment portion 10 is fixed to a tire holding unit by bolts and nuts. For example, the tire-side attachment portion 10 has a structure similar to a tire attachment portion of a vehicle fixed by, for example, five bolts. As a modification, the tire-side attachment portion 10 may be fixed to the tire holding unit by, for example, one fixing part.

The tire shaving device 1 includes a tire holding unit 12 holding the tire 2, a tire rotation driving unit 14 that rotates the tire 2 in a predetermined rotation direction in a state where the tire 2 is held, and a structure 16 in which the tire holding unit 12 and the tire rotation driving unit 14 are disposed.

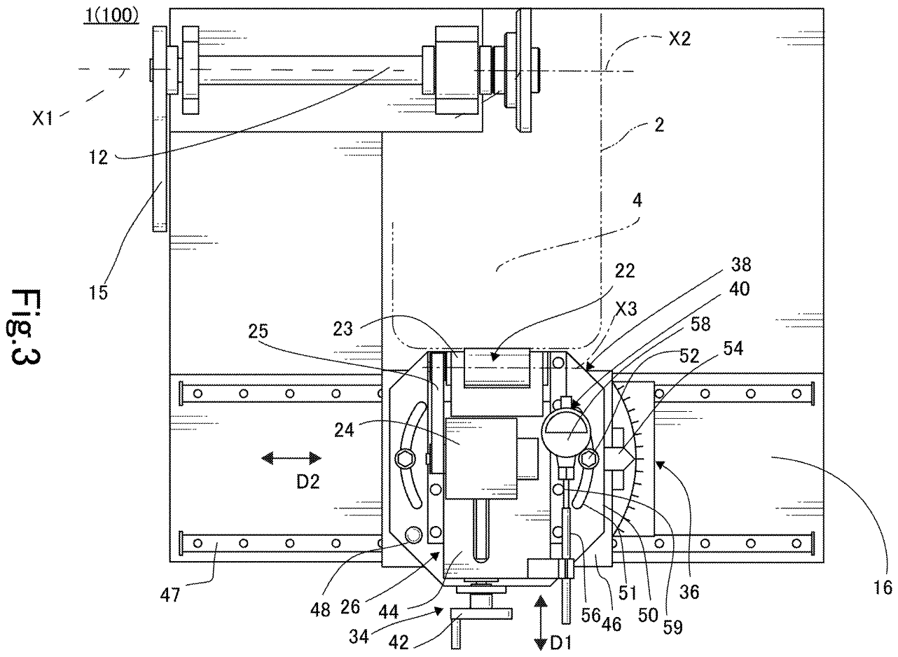

The tire holding unit 12 forms an attachment portion to which the tire is attached. The tire 2 is attached to the tire holding unit 12 such that a center axis X1 (see FIG. 3) of the tire holding unit 12 is substantially coincident with a center axis X2 of the tire 2. The tire holding unit 12 has a structure similar to an attachment portion for the tire 2 in a common vehicle, and the wheel portion 8 of the tire and the tire holding unit 12 are fixed by a plurality of bolts and nuts. The tire holding unit 12 may be configured to fix the wheel portion 8 and the tire holding unit 12 with simpler attachment members, for example, by a center lock method of fixing the wheel portion 8 and the tire holding unit 12 with a bolt and a nut at one position by using a hole at a center of the wheel.

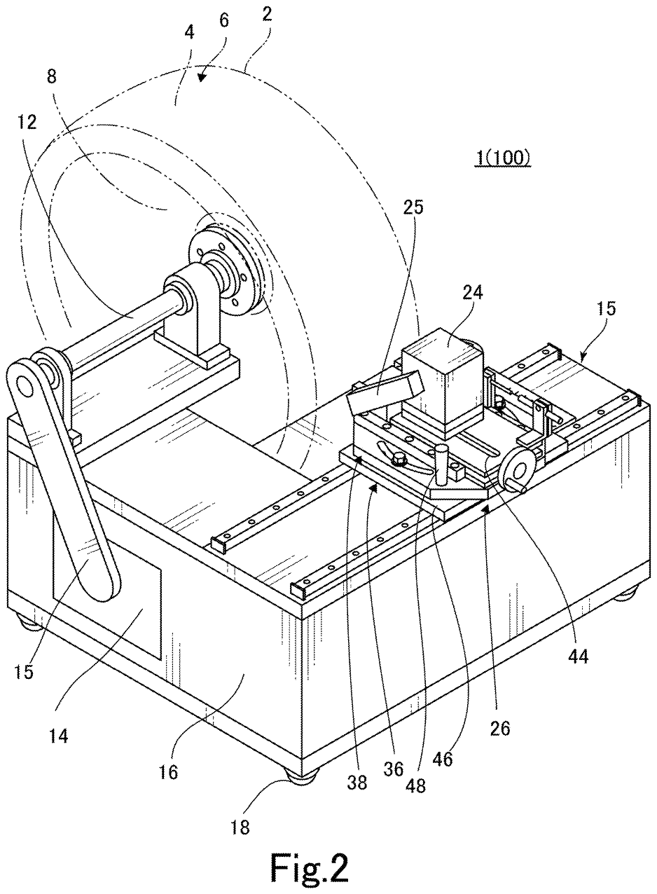

As illustrated in FIG. 2, the tire rotation driving unit 14 is connected to the tire holding unit 12 through a pulley (not illustrated) and a belt (not illustrated) incorporated in a tire rotation transmission unit 15. The tire rotation driving unit 14 is an electric motor. The tire rotation driving unit 14 transmits rotation of the motor to the tire holding unit 12 through the pulley (not illustrated) and the belt (not illustrated) in the tire rotation transmission unit 15. As a modification, the tire rotation driving unit 14 may be connected to the tire holding unit 12 through a gear and the like incorporated in the tire rotation transmission unit 15. As another modification, the tire rotation driving unit 14 may be directly connected to the tire holding unit 12 without through the belt (not illustrated) and the like, and may transmit rotation to the tire holding unit 12.

The tire rotation driving unit 14 is configured to adjust a rotational speed of the tire holding unit 12 and the tire 2 to, for example, a rotational speed in a range from 0.5 rpm to 5 rpm. The tire rotation driving unit 14 can include a deceleration gear and the like, and is configured to realize a desired rotational speed of the tire. The tire rotation driving unit 14 is electrically connected to an external power supply, but may be configured using a battery or the like, and a wiring with an outside can be omitted. A rotation direction B of the tire 2 may be the opposite rotation direction. The rotation direction of the tire 2 and a rotation direction of a blade 20 may be the same rotation direction.

The structure 16 is mounted with components described below of the tire shaving device 1. For example, the structure 16 is mounted with a first adjustment mechanism, a second adjustment mechanism, a blade angle adjustment mechanism, and the like. The structure 16 includes movable wheels 18 that are movable portions for facilitating movement of the tire shaving device 1. The structure 16 is mainly formed by frames and plates each made of a metal such as aluminum. Therefore, in a state where the tire 2 is not attached to the tire shaving device 1, the tire shaving device 1 has a weight in a range from about 70 kg to about 200 kg, for example, a weight of about 100 kg. Thus, the tire shaving device 1 has a weight that can be conveyed by about three average-sized adults or can be pushed and moved by an average-sized adult by using the movable wheels 18 attached to the apparatus disposed on a concrete surface. For example, the tire shaving device 1 can be moved by human hands in order to facilitate setting of the tire in a circuit and the like. Further, for example, the tire shaving device 1 is configured as one movable device that has a size of about one square meter and a weight of about 100 kg. Therefore, the tire shaving device 1 can be relatively easily carried into the circuit without being limited to a factory, and setting of the tire can be freely adjusted on site.

The tire shaving device 1 further includes the blade 20 that performs cutting to shave the surface of the tire 2, a blade attachment portion 22 to which the blade 20 is attached, a blade rotation driving unit 24 rotating the blade attachment portion 22, a positioning unit 26 that can position the blade 20 at a predetermined distance from the center axis X2 of the tire 2, and a control unit 60 (see FIG. 1) controlling the tire rotation driving unit 14 and the blade rotation driving unit 24.

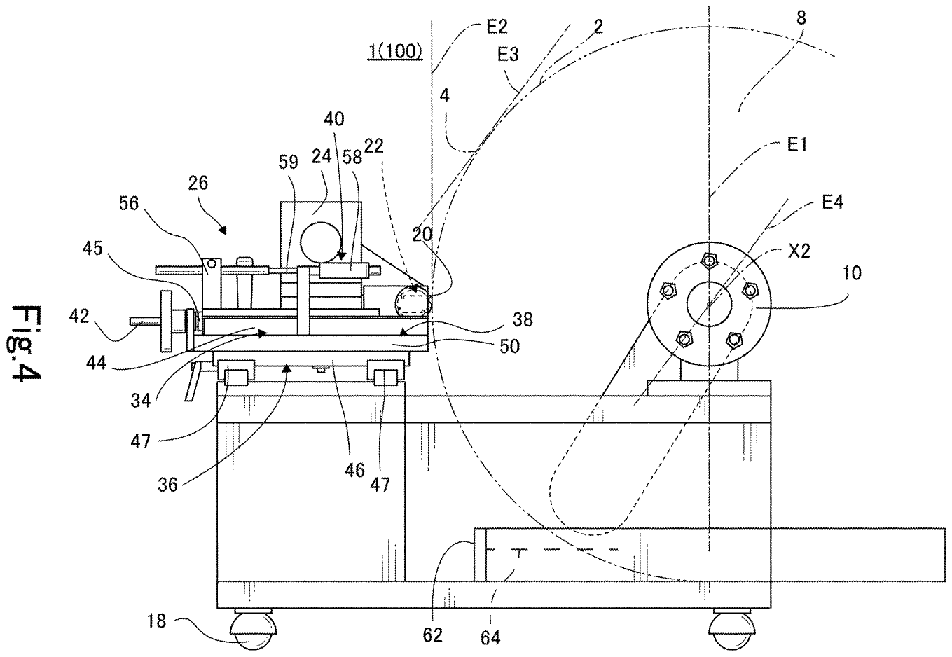

The blade 20 is disposed such that, in a state of being attached to the blade attachment portion 22 and in a basic posture for making the tread portion 4 relatively flat, the center axis X2 of the tire 2 and a blade edge line along a blade edge 20a of the blade 20 are positioned on two parallel virtual planes (first virtual plane and second virtual plane, respectively). A first virtual plane El including the center axis X2 is, for example, a vertical plane including the center axis X2, and a second virtual plane E2 including the blade edge line along the blade edge 20a is, for example, another vertical plane including the blade edge 20a. Each of the first virtual plane El and the second virtual plane E2 is illustrated by an alternate long and short dash line in FIG. 4. The second virtual plane E2 and an oblique second virtual plane E3 described below are planes extending in a tangential direction of the tire 2. The blade edge line along the blade edge 20a may obliquely extend on the second virtual plane E2. In other words, the blade edge 20a may be set to an angle other than a direction parallel to the center axis X2 on such a second virtual plane E2 (for example, an angle inclined by five degrees such that the right side of the blade edge is positioned above the left side). As described as a modification, the blade edge line along the blade edge 20a may be inclined at an angle in a range from +45 degrees to −45 degrees in the tangential direction of the tire from a state parallel to the center axis X2.

Each of the virtual planes may be set as an oblique virtual plane. In other words, the first virtual plane including the center axis X2 may be an oblique first virtual plane E4. The second virtual plane including the blade edge line along the blade edge 20a (the blade edge 20a at this time is positioned on E3 above the position of the blade edge illustrated in FIG. 4) may be an oblique second virtual plane E3. FIG. 4 also illustrates the oblique first virtual plane E4 and the oblique second virtual plane E3. Such two virtual planes, for example, the oblique first virtual plane E4 and the oblique second virtual plane E3 extend in parallel to each other.

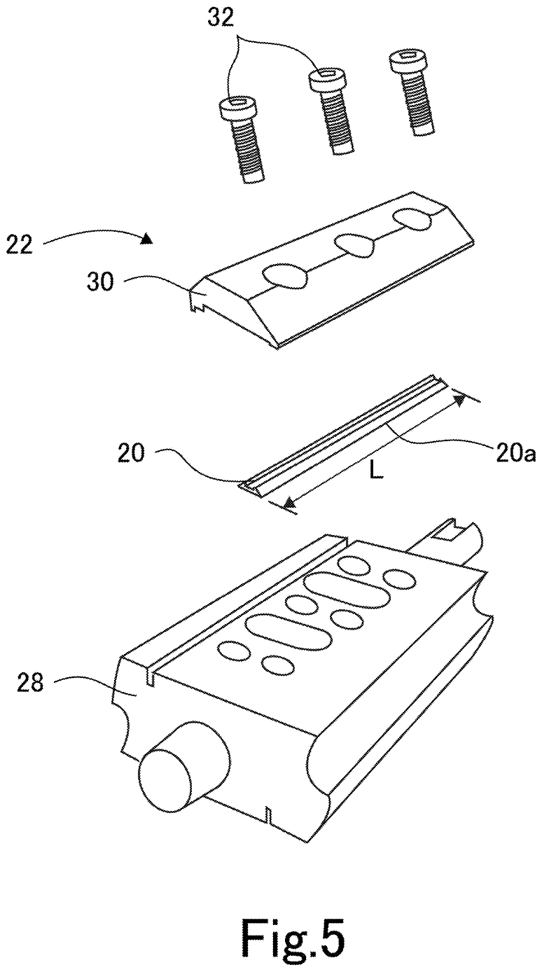

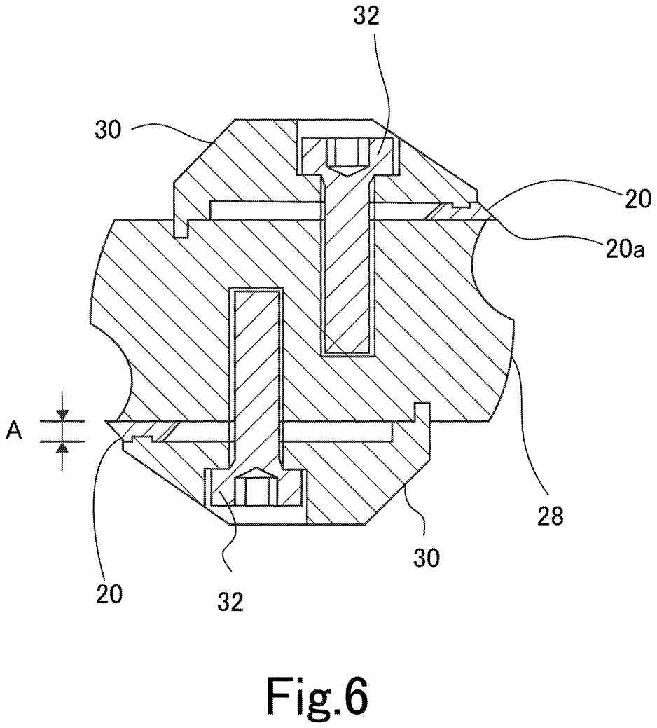

Further, the blade 20 forms the blade edge 20a that extends in a direction parallel to the center axis X2 of the tire 2 in the basic posture. The blade 20 is disposed such that, when the blade edge 20a of the blade 20 attached to the blade attachment portion 22 comes into contact with the surface of the tire 2, the blade edge 20a is directed to an upstream-side direction in the rotation direction B of the tire 2. The blade edge 20a may not be directed to the upstream-side direction in the rotation direction B. The blade 20 is formed in a rod shape having a relatively thin thickness and extends in a linear shape. For example, the blade 20 is formed in a blade shape like a razor blade. The blade edge 20a of the blade 20 has a length L in a range from 50 mm to 310 mm in a longitudinal direction (see FIG. 5) and also, for example, a length in a range from 80 mm to 150 mm. The blade 20 has, for example, a thickness A (see FIG. 6) in a range from 1 mm to 3 mm and also, for example, a thickness in a range from 1.5 mm to 2.5 mm. The blade 20 is formed such that a blade angle al of the blade edge 20a is, for example, an angle in a range from 30 degrees to 60 degrees, also for example, an angle in a range from 35 degrees to 55 degrees, further for example, an angle in a range from 40 degrees to 50 degrees, and further, for example, an angle in a range from 43 degrees to 48 degrees. In addition, the blade 20 is formed such that a rake angle α2 of the blade 20 is, for example, an angle in a range from 25 degrees to 35 degrees. As described above, when the blade 20 is inserted into the tire at a relatively large angle to a tangent of the surface of the tire, the blade 20 can shave the surface of the tire so as to cleave the surface of the tire while suppressing friction. Accordingly, it is possible to suppress thermal deterioration of the shaved surface. The blade 20 is a replaceable blade, and can be replaced or resharpened when becoming dull.

The blade attachment portion 22 includes a main body portion 28 on which the blade 20 is placed, and a retaining portion 30 retaining the blade 20 between the retaining portion 30 and the main body portion 28. The blade 20 is retained to be sandwiched between the main body portion 28 and the retaining portion 30. The retaining portion 30 is attached to the main body portion 28 by bolts 32. By fastening the bolts 32, the retaining portion 30 is fixed to the main body portion 28, and the blade 20 is fixed to the main body portion 28.

The blade attachment portion 22 forms an assembly having a substantially cylindrical cross-section and forms a substantially circular outer peripheral portion in a state where the main body portion 28, the blade 20, and the retaining portion 30 are assembled. A center axis X3 (see FIG. 3) of the blade attachment portion 22 is disposed in parallel with the center axis X1 of the tire holding unit and the center axis X2 of the tire 2. Further, the center axis X3 and the center axis X2 are at the same height position. The blade attachment portion 22 holds the blade 20 such that the blade 20 extends in a direction parallel to the center axis X3. The blade attachment portion 22 is rotatably supported between support arms 23. The blade attachment portion 22 is rotated with rotation transmitted from the blade rotation driving unit 24. The blade attachment portion 22 is rotated such that, in the state where the blade 20 is attached to the blade attachment portion 22, the blade edge 20a is directed to the upstream-side direction in the rotation direction B of the tire 2. A rotation direction C of the blade attachment portion 22 may be the opposite rotation direction.

The blade attachment portion 22 is formed such that, in the state where the blade 20 is attached to the blade attachment portion 22, the blade 20 protrudes by, for example, an amount in a range from 0.5 mm to 2 mm from an outer peripheral surface of the blade attachment portion 22 and also, for example, an amount in a range from 0.5 mm to 1.5 mm. Therefore, the tire is shaved up to a depth corresponding to the protruding amount, from the surface of the tire. Since the protruding amount is set to a relatively small value, it is possible to suppress a load and friction applied to the surface of the tire in single cutting, and to suppress generation of heat. Further, cutting is performed to shave a surface layer of the tire 2, for example, up to a depth of about 0.1 mm to about 1 mm and also, for example, up to a depth of about 0.1 mm to about 0.5 mm, which makes it possible to remove only a surface portion easily affected by heat. Further, since the surface is shaved by the blade, a smooth surface is formed as if the surface is cut away by a sharp blade. Therefore, as compared with a surface polished by a grinding stone such as a sander, a smooth surface is formed, and fine irregularities on the surface that causes a deterioration in travel time can be suppressed. Furthermore, by limitedly removing only the surface layer of the tire 2, a tread layer of the tire 2 can be retained to enable re-removal of the surface layer of the tire 2 after traveling use (for example, after time trial traveling in the circuit), and the surface layer of the tire 2 can be removed for traveling a plurality of times every use. The shaving is performed with consideration for safety of the tire as a matter of course. Note that, for example, in a state where the blade 20 and the blade attachment portion 22 are assembled, a diameter o of a workpiece is about 48 mm.

The blade rotation driving unit 24 is connected to the blade attachment portion 22 through a pulley (not illustrated) and a belt (not illustrated) incorporated in a blade rotation transmission unit 25. The blade rotation driving unit 24 is an electric motor. The blade rotation driving unit 24 transmits rotation of the motor to the blade attachment portion 22 through the pulley and the belt in the blade rotation transmission unit 25. The blade rotation driving unit 24 is configured to adjust a rotational speed of the above-described blade attachment portion to, for example, a rotational speed in a range from 100 rpm to 20000 rpm, also for example, a rotational speed in a range from 1000 rpm to 10000 rpm, and further, for example, a rotational speed in a range from 1000 rpm to 8000 rpm. For example, it is sufficient that the rotational speed of the above-described blade attachment portion rotated by the blade rotation driving unit 24 is a rotational speed relatively larger than the rotational speed of the tire, for example, a rotational speed of 100 rpm or more. The tread portion mainly made of a rubber is relatively soft as compared with the blade made of a metal. Therefore, the rotational speed is relatively large for shaving even at the rotational speed of 100 rpm or more. Thus, the rotational speed of the blade attachment portion 22 is adjusted to, for example, a rotational speed in a range from 100 rpm to 20000 rpm, also for example, a rotational speed in a range from 1000 rpm to 10000 rpm, and further, for example, a rotational speed in a range from 1000 rpm to 8000 rpm. For example, it is sufficient that the rotational speed of the blade attachment portion 22 is a rotational speed relatively larger than the rotational speed of the tire, for example, a rotational speed of 100 rpm or more. The tread portion mainly made of a rubber is relatively soft as compared with the blade made of a metal. Therefore, the rotational speed is relatively large for shaving even at the rotational speed of 100 rpm or more. The blade rotation driving unit 24 is configured to realize the desired rotational speed of the blade attachment portion 22. As a modification, the blade rotation driving unit 24 may be connected to the blade attachment portion 22 through a gear and the like incorporated in the blade rotation transmission unit 25. As another modification, the blade rotation driving unit 24 may be directly connected to the blade attachment portion 22 without through the belt (not illustrated) and the like, and may transmit rotation to the blade attachment portion 22.

A peripheral speed of the above-described blade 20 attached to the above-described blade attachment portion 22 is, for example, a value in a range from 150 m/min to 3000 m/min and also, for example, a value in a range from 150 m/min to 1300 m/min. The peripheral speed is a speed in a tangential direction of the blade in a case where the blade is rotated, and indicates a speed of the blade edge. The peripheral speed is determined from “peripheral speed”=diameter of workpiece (for example, the diameter o of the workpiece obtained by assembling the blade and the blade attachment portion=48 mm)×π×rotational speed of workpiece (for example, 4000 rpm)+1000. For example, when the diameter o of the workpiece is 48 mm, the peripheral speed is determined as peripheral speed=(φ48 mm×π×4000 rpm÷1000=603.2 m/min. Further, for example, when the diameter o of the workpiece is 48 mm, the peripheral speed is determined as peripheral speed=φ48 mm×π×20000 rpm÷1000=3014.4 m/min.

Further, for example, when the diameter o of the workpiece is 48 mm and the rotational speed of the workpiece is 1000 rpm, the peripheral speed is determined as peripheral speed=φ48 mm×π×1000 rpm÷1000=150.7 m/min. Further, for example, when the diameter o of the workpiece is 48 mm and the rotational speed of the workpiece is 8000 rpm, the peripheral speed is determined as peripheral speed=φ48 mm×π×8000 rpm÷1000=1205.7 m/min. As described above, the peripheral speed of the above-described blade may be, for example, a value in a range from 150 m/min to 1300 m/min.

In the case where the blade has the speed of the blade edge as described above, when the blade edge 20a is inserted into the surface of the tire 2, the surface of the tire 2 is easily cut from a position on the upstream side of a tip of the blade edge 20a, and generation of heat when the surface is shaved can be suppressed.

The positioning unit 26 includes a first adjustment mechanism 34 that is configured to be able to move the blade 20 and the blade attachment portion 22 in a first direction toward the tire 2, a second adjustment mechanism 36 that is configured to be able to move the blade 20 and the blade attachment portion 22 in a second direction orthogonal to the first direction, a blade angle adjustment mechanism 38 that is configured to be able to adjust inclination of the blade 20 between the first direction and the second direction, and a measurement device 40 (see FIG. 3) that measures the protruding amount of the blade 20.

The first adjustment mechanism 34 is provided to be movable in the first direction in a state where the blade 20, the blade attachment portion 22, the blade rotation driving unit 24, and the like are placed on the first adjustment mechanism 34. The first direction is, for example, a direction directed from an outside in a radial direction of the tire 2 toward a center as illustrated by an arrow DI (see FIG. 3). The first direction is, for example, a front-rear direction. Therefore, the first adjustment mechanism 34 adjusts positions of the blade attachment portion 22 and the blade 20 in the first direction, for example, in the front-rear direction.

The first adjustment mechanism 34 includes a handle portion 42 that can be operated manually by an operator, and a first position adjustment table 44 that is movable in the first direction in a state where the blade 20, the blade attachment portion 22, and the blade rotation driving unit 24 are placed on the first position adjustment table 44. In the first adjustment mechanism 34, when the handle portion 42 is rotationally operated, a screw shaft 45 is rotated, and the first position adjustment table 44 is moved in the front-rear direction. The first adjustment mechanism 34 forms a screw-type position adjustment mechanism. For example, the first position adjustment table 44 is movable forward/rearward by about 100 mm in the first direction. Note that the position of the first adjustment mechanism 34 in the first direction may be adjusted by an electric driving unit.

The first position adjustment table 44 is disposed above a blade angle adjustment table of the blade angle adjustment mechanism 38, and is provided to move forward/rearward relative to the table below the first position adjustment table 44. The first adjustment mechanism 34 is provided to adjust the position of the blade edge 20a of the blade 20 with relatively high accuracy, for example, in units of millimeters, further for example, in units of 0.1 millimeters or less (for example, in units of 0.01 millimeters).

The second adjustment mechanism 36 is provided to be movable in the second direction in a state where the first adjustment mechanism 34 and the blade angle adjustment mechanism 38 are placed on the second adjustment mechanism 36. The second direction is a direction orthogonal to the first direction, for example, a direction along the center axis X2 of the tire 2 as illustrated by an arrow D2 (see FIG. 3). The second direction is, for example, a direction orthogonal to the first direction in a horizontal plane, for example, a left-right direction. Therefore, the second adjustment mechanism 36 adjusts the positions of the blade attachment portion 22 and the blade 20 in the second direction, for example, in the left-right direction.

The second adjustment mechanism 36 includes a second position adjustment table 46 that is movable in the second direction in a state where the first adjustment mechanism 34 and the blade angle adjustment mechanism 38 are placed on the second position adjustment table 46. The second position adjustment table 46 is slidably disposed on rails 47 parallelly extending in the left-right direction, and is provided to be movable on the rails by manual operation of the operator. For example, the second position adjustment table 46 is movable by about 450 mm in the second direction. Note that the position of the second adjustment mechanism 36 in the second direction may be adjusted by the electric driving unit.

The second position adjustment table 46 is substantially horizontally disposed on the structure 16, and is provided to move leftward/rightward relative to a top surface of the structure 16. Therefore, the second adjustment mechanism 36 is provided to adjust the position of the blade edge 20a of the blade 20 in the left-right direction on the horizontal plane.

Thus, the blade 20 is positioned by the first adjustment mechanism 34 and the second adjustment mechanism 36.

The blade angle adjustment mechanism 38 is provided so as to be able to change inclination of the own mechanism in the left-right direction in a state where the first adjustment mechanism 34 is placed on the blade angle adjustment mechanism 38. Thus, the blade angle adjustment mechanism 38 can adjust inclination of the blade attachment portion 22 and the blade 20 on the first adjustment mechanism 34 in the left-right direction.

The blade angle adjustment mechanism 38 includes a grip portion 48 manually operated by the operator, and an angle adjustment table 50 that is pivotable in the left-right direction on the horizontal plane in a state where the first adjustment mechanism 34 is placed on the angle adjustment table 50. The angle adjustment table 50 of the blade angle adjustment mechanism 38 includes two arc-shaped groove portions 51, and protruding portions 52 extending upward from the second adjustment table are inserted into the respective two groove portions 51. Therefore, the angle adjustment table 50 is provided to be pivotable in a flat plane on the second position adjustment table 46. The angle adjustment table 50 further includes a scale indicating portion 54 indicating scale marks. The scale indicating portion 54 indicates any of scale marks on a scale plate provided on a side of the second position adjustment table 46 and below the scale indicating portion 54. For example, angles from −30 degrees to +30 degrees as described below are drawn as the scale marks. The operator grips the grip portion 48 to pivotally operate the blade angle adjustment mechanism 38, and accordingly, the direction of the blade 20 (the angle to the center axis X2 of the tire) is changed. Note that the blade angle adjustment mechanism 38 may be configured by an electric pivoting device.

The blade angle adjustment mechanism 38 is provided such that, in the basic posture at the angle of zero degrees (the basic posture at the angle of zero degrees is illustrated in FIG. 3), a blade edge line along the blade edge 20a of the blade 20 is parallel to the center axis X2 of the tire. In the blade angle adjustment mechanism 38, in the basic posture at the angle of zero degrees, the blade is disposed such that the blade edge line along the blade edge 20a of the blade 20 is disposed on the second virtual plane E2 (oblique second virtual plane E3) parallel to the first virtual plane E1 (oblique first virtual plane E4) passing through the center axis X2 of the tire 2. The blade edge 20a may be set to an angle other than the direction parallel to the center axis X2 on such a second virtual plane E2 (oblique second virtual plane E3) (for example, the angle inclined by five degrees such that the left side of the blade edge is positioned above the right side).

Further, the blade angle adjustment mechanism 38 is configured to adjust the inclination of the blade 20 to, for example, an angle in a range from −40 degrees to +40 degrees and also, for example, an angle in a range from −30 degrees to +30 degrees on the horizontal plane. When the angle of the blade angle adjustment mechanism 38 is −30 degrees, the line along the blade edge of the blade is inclined leftward by 30 degrees relative to the center axis X2. When the angle of the blade angle adjustment mechanism 38 is +30 degrees, the line along the blade edge of the blade is inclined rightward by 30 degrees relative to the center axis X2. The blade angle adjustment mechanism 38 can relatively accurately adjust such an angle of the blade 20 at a level of one degree or less.

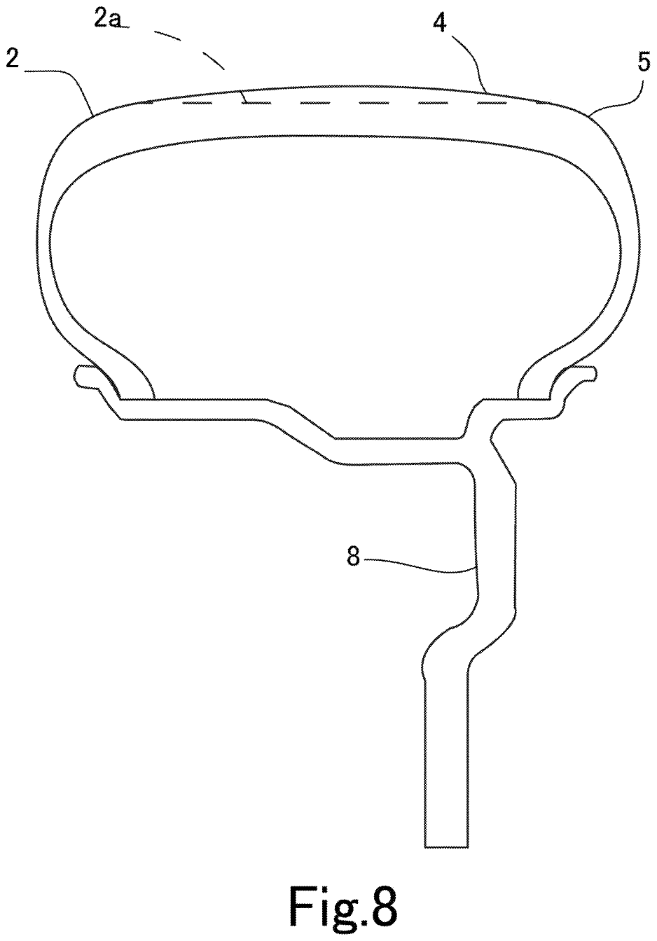

The blade angle adjustment mechanism 38 is substantially horizontally disposed on the second position adjustment table 46, and is provided to change the angle relative to the second position adjustment table 46. Therefore, the blade angle adjustment mechanism 38 is provided to adjust the inclination angle of the blade edge 20a of the blade 20. In other words, the second adjustment mechanism 36 can direct the blade 20 in the left-right direction with the tire 2 as the center. Further, such a blade angle adjustment mechanism 38 can relatively precisely set setting angles of the shaved surfaces of the tread portion 4 (see FIG. 8) and the shoulder portion 5 (see FIG. 8) of the tire 2. Therefore, the blade 20 is positioned by the first adjustment mechanism 34 and the second adjustment mechanism 36 and is adjusted in inclination by the blade angle adjustment mechanism 38, shaves the surface of the tire 2 in an intended shape, and adjusts the motor sport tire 2 to a shape having desired traveling characteristics.

The measurement device 40 measures a moving amount of the blade 20 moved in the first direction by the first adjustment mechanism 34 (a protruding amount of the blade 20 toward the tire). The measurement device 40 includes a first table-side measurement unit 56 provided to stand from the first position adjustment table 44 of the first adjustment mechanism 34, and a measurement instrument 58 attached to a supporting portion extending from the angle adjustment table 50 of the blade angle adjustment mechanism 38. The first table-side measurement unit 56 is attached to an upper surface of the first position adjustment table 44, and is provided to stand upward from the first position adjustment table 44. The first table-side measurement unit 56 is used as a reference unit for measuring a position of the first position adjustment table 44.

The measurement instrument 58 can measure a moving distance of the first position adjustment table 44 relative to the angle adjustment table 50. More specifically, the measurement instrument 58 can measure the moving (protruding) distance of the first table-side measurement unit 56 from a position abutting on a measurement instrument-side measurement unit 59 of the measurement instrument 58 in the first direction. The measurement instrument 58 is, for example, a dial gauge. The measurement instrument 58 includes the measurement instrument-side measurement unit 59 that measures a distance based on a distance pushed inside the measurement instrument 58. The measurement instrument 58 displays a distance by which the measurement instrument-side measurement unit 59 is pushed in from a position abutting on the first table-side measurement unit 56. The measurement instrument can relatively accurately measure the distance, for example, even in units of 0.01 mm. Using such a measurement device 40 makes it possible to manage the depth and the amount of shaving to desired amounts. Further, the shaving amounts of the right and left tires 2 of the vehicle can be made equal to each other. In addition, the blade can be accurately positioned, and the shaving angles of the right and left tires 2 of the vehicle can be made bilaterally symmetrical. Thus, it is possible to suitably set traveling performance corresponding to right and left curves.

The positioning unit 26 can fix and position the blade 20 at a predetermined distance from the center axis X2 of the tire 2, and the surface of the tire 2 can be shaved. The tire is essentially a rubber molded product. Therefore, shape accuracy of the tire is relatively varied in manufacturing; however, by daringly shaving the tire by the configuration according to the present embodiment, it is possible to form the tire 2 in a circular shape having a substantially uniform diameter (for example, a true circle) with relatively high accuracy. As a result, in traveling of the motor sport, ground contact of the tire 2 in high-speed traveling becomes more stable, and the time necessary for one round of the circuit can be further reduced at a level of, for example, 0.1 seconds.

The control unit 60 (see FIG. 1) controls the rotational speeds, ON/OFF, and the like of the tire rotation driving unit 14 and the blade rotation driving unit 24 (and the rotational speed of the tire 2 and the rotational speeds of the blade attachment portion 22 and the blade 20 through the rotational speeds of the tire rotation driving unit 14 and the blade rotation driving unit 24). The control unit 60 controls the connected devices so as to control the rotational speeds, ON/OFF, and the like by dial operation. In a case where each of the units of the positioning unit 26 is configured by an electric device, the control unit 60 may electrically control these devices. The control unit 60 is mutually electrically connected to the tire rotation driving unit 14, the blade rotation driving unit 24, and the like. The electric connection may be established by wireless communication or the like. In a case where the control unit 60 automatically controls the tire rotation driving unit 14, the blade rotation driving unit 24, and the like based on programs, the control unit 60 may include a CPU, a memory, and the like. In this case, the control unit 60 controls the connected devices so as to control the rotational speeds, ON/OFF, and the like based on predetermined control programs recorded in the memory and the like.

As illustrated in FIG. 4, the tire shaving device 1 may further include a liquid reservoir portion 62 for reserving liquid 64 containing components of surfactant (in other drawings, illustration of the liquid reservoir portion 62 is omitted). The liquid reservoir portion 62 is disposed below the tire such that the tread portion 4 and the shoulder portion 5 at a lower part of the tire 2 are immersed in the liquid 64. The liquid reservoir portion 62 is formed in a quadrilateral shape as viewed from above, and is formed to reserve inside the liquid 64 (part of the liquid level is illustrated by a dashed line in FIG. 4) containing, for example, components of the surfactant. The liquid 64 containing the components of the surfactant is, for example, liquid obtained by diluting neutral detergent with water, or soapy water. The liquid 64 containing the components of the surfactant enables the edge of the blade to smoothly shave the tire. The liquid reservoir portion 62 is provided such that a lowermost part of the tire 2 in a state of being held by the tire holding unit 12 is stored inside the liquid reservoir portion 62, and lower end parts of the tread portion 4 and the shoulder portion 5 are immersed in the liquid 64. This makes it possible to wet the surface of the tire, and to cool the tire by cooling with the liquid and cooling associated with evaporation of the liquid, and thereby facilitate shaving by the blade edge. In particular, in a case where the temperature of the tire is relatively high, when the tire is shaved while being cooled by the liquid reservoir portion 62, the tire can be easily shaved in a predetermined shape. Even when liquid not containing the components of the surfactant, for example, water is used in place of the liquid containing the components of the surfactant, a certain effect of cooling the tire and the like can be achieved. The liquid reservoir portion 62 may be omitted.

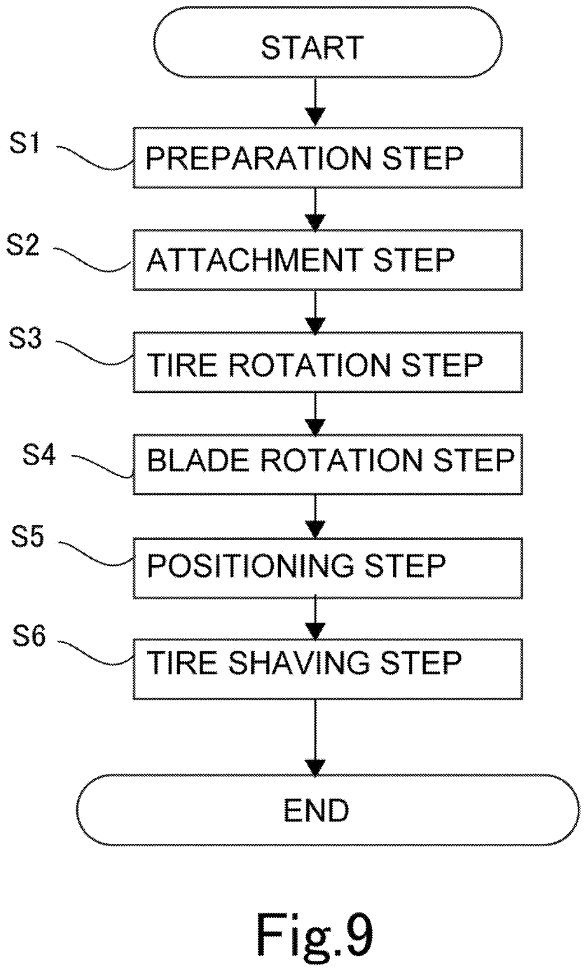

Next, a tire shaving method by the tire shaving device 1 according to the present embodiment is described with reference to FIG. 9.

As illustrated in FIG. 9, in the tire shaving method, in S1, a preparation step of preparing the tire shaving device 1 as described above is first performed. In the tire shaving device 1, for example, the blade 20 is attached to the blade attachment portion 22, and the tire shaving device 1 is put into an operable state. After the preparation step S1 of preparing the tire shaving device 1 is performed, the method proceeds to S2.

In S2, an attachment step of attaching the tire 2 having a surface to be shaved, to the tire holding unit 12 is performed. The tire 2 is rotatably held by the tire holding unit 12. After the attachment step S2 is performed, the method proceeds to S3.

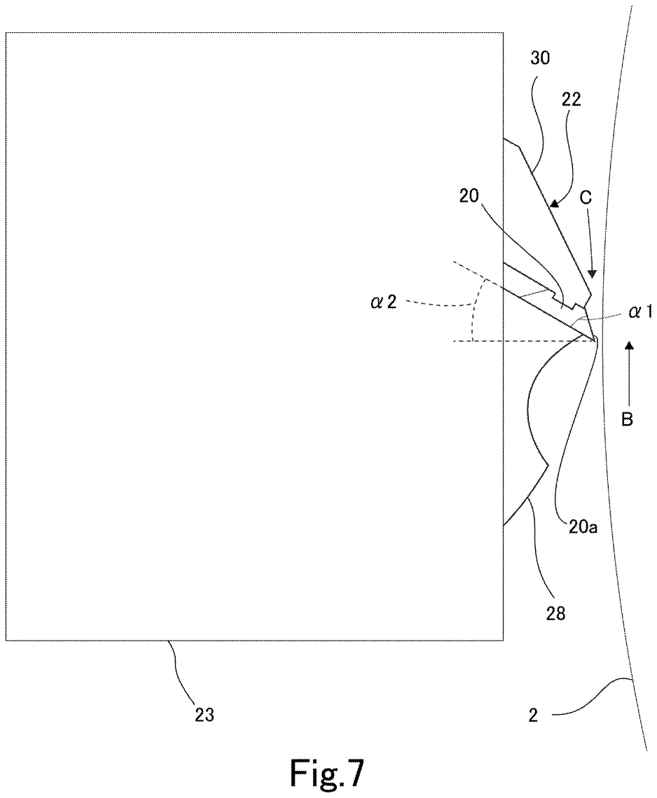

In S3, a tire rotation step is performed. The tire 2 is rotated in a predetermined rotation direction by the tire rotation driving unit 14 while being held by the tire holding unit 12. In the tire rotation step S3, the tire 2 is rotated at the rotational speed in a range from 0.5 rpm to 5 rpm in the rotation direction illustrated by an arrow B (see FIG. 7). After the tire rotation step S3 is performed, the method proceeds to S4.

In S4, a blade rotation step of rotating the blade attachment portion 22 to which the blade 20 has been attached is performed. In the blade rotation step S4, the blade attachment portion 22 and the blade 20 are rotated in a predetermined rotation direction as illustrated by an arrow C (see FIG. 7). The blade attachment portion 22 and the blade 20 are rotated at the rotational speed in a range from 1000 rpm to 8000 rpm. After the blade rotation step S4 is performed, the method proceeds to S5. The tire rotation step S3 and the blade rotation step S4 may be performed in a reverse order, or may be synchronized with each other so as to be performed substantially at the same time.

Thereafter, in S5, a positioning step S5 of positioning the blade 20 at a predetermined distance from the center axis X2 of the tire 2 is performed. In the positioning step S5, the positioning unit 26 positions the blade 20, for example, the blade edge 20a of the blade 20 at the predetermined distance from the center axis X2 of the tire. As a result, it is possible to set the shaving depth of the surface of the tire 2 by the blade 20, and to set the diameter (and shape) of the tire to be finally formed. When the positioning step S5 is performed and the blade edge 20a of the blade 20 is advanced to the position where the blade edge 20a abuts on the tire 2, shaving of the surface is started, and the method automatically proceeds to S6. In other words, S5 and S6 may be performed substantially at the same time. A part of the positioning step S5 may be performed at the same time or around the same time as the steps up to S4. For example, the positioning in the second direction by the second adjustment mechanism 36 may be performed before S3.

Thereafter, in S6, a tire shaving step S6 of performing cutting to shave the surface of the tire 2 by the blade 20 is performed. In the tire shaving step S6, the blade 20 is rotated at the predetermined rotational speed by the blade rotation driving unit 24. In addition, the tire 2 is also rotated at the predetermined rotational speed by the tire rotation driving unit 14. When the rotated blade 20 abuts on the surface of the tire, the surface of the tire is shaved. Therefore, a thermally-deteriorated portion (hardened and deteriorated portion) of the surface of the tire generated by heat cycle in traveling can be wholly or at least partially removed. Further, the blade 20 can shave off the surface of the tire while suppressing deterioration of the surface of the tire caused by heating during shaving. In other words, as compared with heat generated in a case where the surface of the tire is polished, heat generated in a case where the surface of the tire is shaved is relatively small. Therefore, it is possible to suppress deterioration of the surface of the tire caused by heating. A position where shaving of the tire 2 by the blade 20 is started is marked on the tire 2, the shaving is performed by one round of the tread portion 4, and then the blade edge 20a of the blade 20 is further advanced toward the tire 2 by the first adjustment mechanism 34. As described above, the tire 2 is shaved a plurality of times while the shaving depth in single shaving operation is suppressed to, for example, about 0.1 mm to about 1 mm, which makes it possible to suppress the load applied to the tire.

In the tire shaving step S6, the surface of the tire may be shaved in a state where the liquid reservoir portion 62 is provided below the tire 2 and the lower end parts of the tread portion and the shoulder portion of the tire 2 are immersed in the liquid 64. The liquid such as liquid obtained by diluting neutral detergent with water and soapy water is reserved in the liquid reservoir portion 62, and the surface of the tire is shaved while being cooled. This makes it possible to more efficiently process the surface of the tire. With such a configuration, an effect in which the surfactant of the neutral detergent improves lubrication during shaving is achieved, and an effect in which the rubber of the tire is cooled and easily cut during shaving is achieved. The tire shaving step S6 can be performed even without wetting the tire.

Further, the blade 20 has a linear blade edge, and the surface of the tire 2 is cut and shaved off over a predetermined width in the left-right direction. As a result, the tread portion 4 of the tire 2 can be easily shaved flat.

When the surface of the tire 2 is shaved off by the blade 20, not a working surface for retread but a traveling surface (the surface of the tread portion 4 and the surface of the shoulder portion 5 for traveling) of the tire can be formed at a predetermined distance from the center axis of the tire 2. The traveling surface is, for example, a ground-contact surface of the tread portion with a road surface, and also, for example, a traveling ground-contact surface of the tread portion with a road surface and/or a traveling ground-contact surface of the shoulder portion with a road surface. The blade 20 does not remove only spews of the tire 2, but shaves off the surface so as to form a flat surface of a predetermined width on the tread portion 4 where spews are formed. Therefore, it is possible to prevent fine irregularities at base parts of the spews from remaining on the tread portion, and to form, by the blade 20, the traveling surface for time trial traveling and the like in which the fine irregularities on the surface are suppressed.

FIG. 8 illustrates a state of the tire after being shaved. FIG. 8 is a partial enlarged cross-sectional view illustrating, in an enlarged manner, a part of a cross-section of the tire shaved by the tire shaving device according to the present embodiment. A cross-sectional shape of the tire 2 before being shaved is illustrated by a solid line, and a surface shape of the tread portion 4 of the tire after being shaved is illustrated by a dashed line as a shaved surface 2a. To facilitate understanding of the shaved state, the shaving depth (amount) is merely illustrative. For example, the tread portion 4 of the tire 2 is shaved flat along an axial direction. This forms the traveling surface of the tire that can improve a ground-contact area of the tire 2 in the width direction and can easily bring out the traveling performance of the tire to the utmost limit. Further, the portion of the surface hardened and deteriorated by heat cycle after traveling is shaved. This exposes a relatively soft and fresh surface, and facilitates re-exertion of the original traveling performance of the tire. Further, the tire shaving device 1 can remove dusts and the like adhering to the surface of the tire 2 in circuit traveling. This makes it possible to clean the surface of the tire, and the original traveling performance of the tire is easily exerted in next traveling.

By the steps S1 to S6 in the tire shaving method, the tire having the shaved surface is manufactured. Therefore, these steps are also described as a method of manufacturing a tire having a shaved surface.

According to the embodiment of the present invention configured as described above, by shaving the surface of the tire 2, the traveling surface of the tire 2 can be formed at the predetermined distance from the center axis X2 of the tire 2 while thermal deterioration of the surface of the tire 2 during shaving is suppressed. As a result, the traveling surface for improving ground contact can be formed on the tread portion 4 of the tire 2, and the traveling surface having a shape close to a circle of a predetermined diameter can be formed on the tire 2 while thermal deterioration of the surface of the tire 2 during shaving is suppressed. Therefore, the traveling surface of the tire 2 that can easily bring out the traveling performance of the tire 2 to the utmost limit can be formed. Accordingly, to reduce the time by 0.1 seconds or the like, the original traveling performance of the tire 2 can be easily brought out to the utmost limit in the tire 2 used for time trial and the like in the circuit.

According to the embodiment of the present invention configured as described above, the blade edge line along the blade edge 20a of the blade 20 is disposed on the second virtual plane (for example, the second virtual plane E2 or the oblique second virtual plane E3) parallel to the first virtual plane (for example, the first virtual plane El or the oblique first virtual plane E4) passing through the center axis X2 of the tire 2. Therefore, by shaving the surface of the tire 2, the relatively flat surface along the second virtual plane parallel to the first virtual plane including the center axis X2 of the tire is easily formed on the surface of the tire 2. Accordingly, thermal deterioration caused by shaving of the surface of the tire 2 can be more easily suppressed, and the traveling surface of the tire 2 that can easily bring out the traveling performance of the tire 2 to the utmost limit can be more easily formed.

According to the embodiment of the present invention configured as described above, the blade edge line along the blade edge 20a of the blade 20 is inclined at the angle within the range from +45 degrees to −45 degrees relative to the center axis X2 in the tangential direction of the tire 2 from a state parallel to the center axis X2 of the tire 2. Therefore, by shaving the surface of the tire 2, the relatively flat surface along the plane including the center axis X2 of the tire in the tangential direction of the tire 2 is easily formed on the surface of the tire 2. Accordingly, thermal deterioration caused by shaving of the surface of the tire 2 can be more easily suppressed, and the traveling surface of the tire 2 that can easily bring out the traveling performance of the tire 2 to the utmost limit can be more easily formed.

According to the embodiment of the present invention configured as described above, the blade edge of the blade 20 can extend in the direction parallel to the center axis X2 of the tire 2, and can extend in the direction parallel to the surface of the tire 2. Therefore, by shaving the surface of the tire 2, the surface flat in the direction parallel to the center axis X2 of the tire 2 is easily formed on the surface of the tire 2. Accordingly, thermal deterioration caused by shaving of the surface of the tire 2 can be more easily suppressed, and the traveling surface of the tire 2 that can easily bring out the traveling performance of the tire 2 to the utmost limit can be more easily formed.

According to the embodiment of the present invention configured as described above, the angle of the blade edge 20a is adjusted to the angle within the range from 30 degrees to 60 degrees. Accordingly, generation of heat when the surface of the tire 2 is shaved relatively thinly can be further suppressed. This makes it possible to further suppress thermal deterioration caused by shaving of the surface of the tire 2.

According to the embodiment of the present invention configured as described above, the angle of the blade edge 20a is adjusted to the predetermined angle, and the rotational speed of the blade attachment portion 22 rotated by the blade rotation driving unit 24 is adjusted to the rotational speed within the range from 1000 rpm to 8000 rpm. As a result, when the blade edge 20a is inserted into the surface of the tire 2 toward the upstream side in the rotation direction of the tire 2, the surface of the tire 2 is easily cut off from the position on the upstream side of the tip of the blade edge 20a. Accordingly, generation of heat when the surface of the tire 2 is shaved can be further suppressed. This makes it possible to further suppress thermal deterioration caused by shaving of the surface of the tire 2.

According to the embodiment of the present invention configured as described above, the angle of the blade edge 20a is adjusted to the predetermined angle, and the rotational speed of the blade attachment portion 22 rotated by the blade rotation driving unit 24 is adjusted to be larger than the rotational speed of the tire. As a result, the blade edge 20a rotated by the blade rotation driving unit 24 is inserted into the surface of the tire 2 at a speed larger than the rotational speed of the tire 2. Therefore, even in a case where the tire 2 is rotated, when the blade edge 20a is inserted into the surface of the tire 2 toward the upstream side in the rotation direction of the tire 2, the surface of the tire 2 is easily cut off from the position on the upstream side of the tip of the blade edge 20a. Accordingly, generation of heat when the surface of the tire 2 is shaved can be further suppressed. This makes it possible to further suppress thermal deterioration caused by shaving of the surface of the tire 2.

According to the embodiment of the present invention configured as described above, the peripheral speed of the blade 20 is the value within the range from 150 m/min to 1300 m/min. Therefore, when the blade edge 20a is inserted into the surface of the tire 2, the surface of the tire 2 is easily cut off from the position on the upstream side of the tip of the blade edge 20a. Accordingly, generation of heat when the surface of the tire 2 is shaved can be further suppressed. This makes it possible to further suppress thermal deterioration caused by shaving of the surface of the tire 2.

According to the embodiment of the present invention configured as described above, the tire shaving device 1 further includes the liquid reservoir portion 62 reserving the liquid, and the liquid reservoir portion 62 is disposed such that the lower part of the tire 2 is immersed in the liquid. As a result, the tire 2 can be cooled and easily shaved by the blade 20, and for example, the components of the liquid enable the edge of the blade 20 to smoothly shave the tire 2 in a desired shape.

According to the embodiment of the present invention configured as described above, by shaving the surface of the tire 2, the traveling surface of the tire 2 can be formed at the predetermined distance from the center axis X2 of the tire 2 while thermal deterioration of the surface of the tire 2 during shaving is suppressed. As a result, the traveling surface for improving ground contact can be formed on the tread portion 4 of the tire 2, and the traveling surface having a shape close to a circle of a predetermined diameter can be formed on the tire 2 while thermal deterioration of the surface of the tire 2 during shaving is suppressed. Therefore, the traveling surface of the tire 2 that can easily bring out the traveling performance of the tire 2 to the utmost limit can be formed. Accordingly, to reduce the time by 0.1 seconds or the like, the original traveling performance of the tire 2 can be easily brought out to the utmost limit in the tire 2 used for time trial and the like in the circuit.

The modes for implementing the present invention are not limited to the above-described modes, and other modifications can be further applied. The tire shaving device 1 may further include a third adjustment mechanism that is configured to obliquely incline the blade 20 in the up-down direction. The third adjustment mechanism is a mechanism that can change heights of supporting parts for a right-side portion and a left-side portion of the blade attachment portion 22. Therefore, for example, in the state where the blade 20 is attached to the blade attachment portion 22, the blade edge line along the blade edge 20a is inclined at an angle in a range from +45 degrees to −45 degrees relative to the center axis X2 in the tangential direction of the tire from the state parallel to the center axis X2. For example, the blade edge 20a is disposed with inclination of about five degrees such that a right side of the blade edge 20a is positioned slightly above a left side. The blade is disposed to be obliquely downward from the right side to the left side of the tread portion of the tire. After traveling in a motor sport (for example, the temperature of the tire is relatively high until about one day after high-speed traveling) or in a case where an external temperature is high and the temperature of the tire is relatively high, when the whole of the blade 20 having a predetermined width (for example, a width of about 80 mm) is caused to abut on the surface of the tire 2 to shave the tire up to the depth of, for example, 0.5 mm or more, the rubber cannot bear the load, and an issue may arise that the rubber softly tears like a so-called string cheese. With regard to such an issue, when the blade edge 20a of the blade is inclined in the left-right direction on the plane (for example, the virtual plane E2) in the vertical direction relative to the center axis X2 (for example, the blade 20 and the blade attachment portion 22 are inclined), the load by resistance to the surface of the tire can be suppressed, and the surface of the tire can be prevented from tearing. Further, since the blade 20 is slightly inclined in the up-down direction, the blade 20 can still easily form the plane on the surface of the tire. Thus, such a configuration makes it possible to achieve improvement in both efficiency and reliability of shaving of the tire.

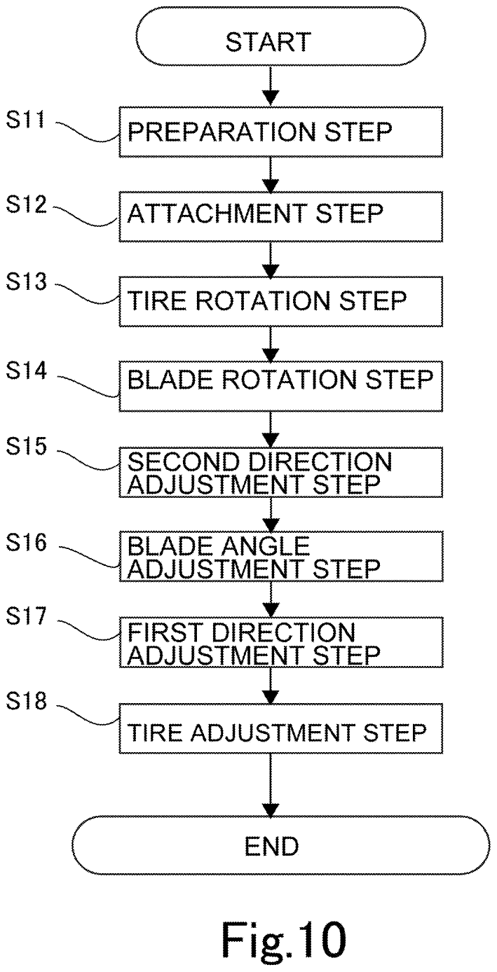

Next, as a second embodiment, a motor sport tire adjustment method in a case where the tire shaving device 1 functions as a motor sport tire adjustment device 100 is described with reference to FIG. 10. The motor sport tire adjustment device 100 according to the second embodiment includes components similar to the components of the tire shaving device 1 according to the first embodiment. The motor sport tire adjustment device 100 includes all or a part of the components of the tire shaving device 1 according to the first embodiment, and can function as a motor sport tire adjustment device. Therefore, the components of the motor sport tire adjustment device 100 are denoted by the reference numerals of the corresponding components of the tire shaving device 1. The motor sport tire adjustment device 100 may include components other than the components of the tire shaving device 1.

As illustrated in FIG. 10, in the motor sport tire adjustment method, in S11, a preparation step of preparing the above-described motor sport tire adjustment device 100 is first performed. In the motor sport tire adjustment device 100, for example, the blade 20 is attached to the blade attachment portion 22, and the motor sport tire adjustment device 100 is put into an operable state. After the preparation step S11 for the motor sport tire adjustment device 100 is performed, the method proceeds to S12.

In S12, an attachment step of attaching the tire 2 having a surface to be shaved, to the tire holding unit 12 is performed. In the attachment step S12, the wheel portion 8 of the tire and the tire holding unit 12 are fixed by bolts and nuts, and the tire 2 is rotatably held by the tire holding unit 12. After the attachment step S12 is performed, the method proceeds to S13.

In S13, a tire rotation step is performed. The tire 2 is rotated in a predetermined rotation direction by the tire rotation driving unit 14 while being held by the tire holding unit 12. In the tire rotation step S13, the tire 2 is rotated at the rotational speed in a range from 0.5 rpm to 5 rpm in the rotation direction illustrated by the arrow B (see FIG. 7). After the tire rotation step S13 is performed, the method proceeds to S14.

In S14, a blade rotation step of rotating the blade attachment portion 22 to which the blade 20 has been attached is performed. In the blade rotation step S14, the blade attachment portion 22 and the blade 20 are rotated in a predetermined rotation direction as illustrated by the arrow C (see FIG. 7). The blade attachment portion 22 and the blade 20 are rotated at the rotational speed in a range from 1000 rpm to 8000 rpm. After the blade rotation step S14 is performed, the method proceeds to S15. The tire rotation step S13 and the blade rotation step S14 may be performed in a reverse order, or may be synchronized with each other so as to be performed substantially at the same time.

Next, out of positioning steps of positioning the blade 20 at the predetermined distance from the center axis X2 of the tire 2, a second direction adjustment step S15 of moving, by the second adjustment mechanism 36, the blade 20 in the second direction orthogonal to the first direction is performed in S15. In the second direction adjustment step S15, the second adjustment mechanism 36 can move the blade 20, for example, the blade edge 20a of the blade 20 in the width direction of the tire, and set a region to be shaved off in the width direction of the tire 2. For example, in a case where the blade edge 20a of the blade 20 is positioned at a position corresponding to the tread portion 4 of the tire 2, the blade 20 shaves off the tread portion 4. For example, in a case where the blade edge 20a of the blade 20 is positioned at a position corresponding to the shoulder portion 5, the blade 20 shaves off the shoulder portion 5. After the second direction adjustment step S15 is performed, the method proceeds to S16.

Thereafter, in S16, a blade angle adjustment step S16 of adjusting, by the blade angle adjustment mechanism 38, inclination of the blade 20 between the first direction and the second direction is performed. In the blade angle adjustment step S16, the blade angle adjustment mechanism 38 can adjust inclination of the blade 20, for example, the blade edge 20a of the blade 20, for example, in the left-right direction. Therefore, it is possible to set the inclination (direction) of the shaved surface when the blade edge 20a of the blade 20 abuts on the surface of the tire 2. For example, in the basic posture (see FIG. 3) in which the angle of the blade angle adjustment mechanism 38 is zero degrees, the blade edge 20a of the blade 20 is parallel to the center axis X2 of the tire, and the shaved surface is formed to be parallel to the center axis X2. Further, for example, in a case where the angle of the blade angle adjustment mechanism 38 is −30 degrees, the blade edge line along the blade edge of the blade is inclined leftward by 30 degrees relative to the center axis X2 on the horizontal plane. Therefore, the shaved surface on the tire 2 is formed to be inclined leftward by 30 degrees relative to the center axis X2 on the horizontal plane. After the blade angle adjustment step S16 is performed, the method proceeds to S17.

Next, in S17, a first direction adjustment step S17 of moving, by the first adjustment mechanism 34, the blade 20 in the first direction toward the tire 2 is performed. In the first direction adjustment step S17, the first adjustment mechanism 34 moves the blade 20, for example, the blade edge 20a of the blade 20 in the first direction toward the tire. Shaving is started from the position where the blade edge 20a of the blade 20 abuts on the surface of the tire (the tire shaving step S18 following S17 is started). A moving (protruding) distance of the blade edge 20a of the blade 20 in the first direction is measured by the measurement instrument side measurement unit 59 of the measurement instrument 58. The measurement instrument-side measurement unit 59 can measure a shaving depth from the position where the blade edge 20a abuts on the surface of the tire. Since the first adjustment mechanism 34 can adjust the moving distance of the blade 20, it is possible to adjust the shaving depth of the surface of the tire 2 by the blade 20, and to adjust the diameter (and shape) of the tire to be finally formed. For example, in a case where the blade edge 20a is moved toward the tread portion 4 of the tire 2 by the first adjustment mechanism 34, the method proceeds to the tire shaving step S18 such that the blade 20 abuts on and shaves off the tread portion 4. For example, in a case where the blade edge 20a is moved toward the shoulder portion 5 by the first adjustment mechanism 34, the method proceeds to the tire shaving step S18 such that the blade 20 abuts on and shaves off the shoulder portion 5. After the first direction adjustment step S17 is performed, the method proceeds to S18. Note that an execution order of the steps S15 to S17 may be different from the above-described execution order. Further, a part of the steps S15 to S17 may be omitted, for example, like a case where movement in the second direction is not performed in the second direction adjustment step S15.

Next, in S18, the tire adjustment step S18 of shaving the surface of the tire 2 in an intended shape and adjusting the motor sport tire 2 in a shape having desired traveling characteristics by the blade 20 that is positioned in the first direction adjustment step S17 and the second direction adjustment step S15 and is adjusted in inclination in the blade angle adjustment step S16, is performed. In the tire adjustment step S18, the surface of the tire 2 is shaved by the blade 20, and is adjusted to have the predetermined traveling performance. The blade 20 is positioned to the predetermined position in the first direction adjustment step S17 and the second direction adjustment step S15, and is adjusted to the predetermined inclination in the blade angle adjustment step S16. In the tire adjustment step S18, the blade attachment portion and the blade 20 are rotated at the predetermined rotational speed by the blade rotation driving unit 24. In addition, the tire 2 is also rotated at the predetermined rotational speed by the tire rotation driving unit 14. When the rotated blade 20 abuts on the surface of the tire, the surface of the tire is shaved. Therefore, a thermally-deteriorated portion (hardened and deteriorated portion) of the surface of the tire generated by heat cycle in traveling can be wholly or at least partially removed. Further, the blade 20 can shave off the surface of the tire 2 to suppress deterioration of the surface of the tire caused by heating in the shaving. In other words, as compared with heat generated in a case where the surface of the tire is polished, heat generated in a case where the surface of the tire is shaved is relatively small. Therefore, it is possible to suppress deterioration of the surface of the tire caused by heating.

In the tire adjustment step S18, the surface of the tire may be shaved outside the liquid reservoir portion 62 in a state where the lower end parts of the tread portion and the shoulder portion of the tire 2 are immersed in the liquid 64 inside the liquid reservoir portion 62. The liquid such as liquid obtained by diluting neutral detergent with water and soapy water is reserved in the liquid reservoir portion 62, and the surface of the tire is shaved while being cooled. This makes it possible to more efficiently shave the surface of the tire. With such a configuration, an effect in which the surfactant of the neutral detergent improves lubrication during shaving is achieved, and an effect in which the rubber of the tire is cooled and easily cut during shaving is achieved. Therefore, it is possible to easily adjust the shape of the tire so as to exert the desired traveling characteristics of the tire at an extremely high level. The tire adjustment step S18 can be performed even without wetting the tire.

The blade 20 has a linear blade edge, and the surface of the tire 2 is cut and shaved off over a predetermined width in the left-right direction. As a result, the tread portion 4 of the tire 2 can be easily shaved flat. When the surface of the tire 2 is shaved off by the blade 20, not a working surface for retread but a traveling surface (the surface of the tread portion 4 and the surface of the shoulder portion 5 for traveling) of the tire can be formed at a predetermined distance from the center axis X2 of the tire 2. The traveling surface is, for example, a ground-contact surface of the tread portion with a road surface and/or a ground-contact surface of the shoulder portion with a road surface. The blade 20 does not remove only spews of the tire 2, but shaves off the surface so as to form a flat surface of a predetermined width on the tread portion 4 where spews are formed. Therefore, it is possible to prevent fine irregularities at base parts of the spews from remaining on the tread portion, and to form, by the blade 20, the flat traveling surface for time trial traveling and the like in which the fine irregularities on the surface are suppressed.

By the steps S11 to S18 in the motor sport tire adjustment method, the tire having the adjusted surface is manufactured. Therefore, these steps are also described as a method of manufacturing a motor sport tire having an adjusted surface.

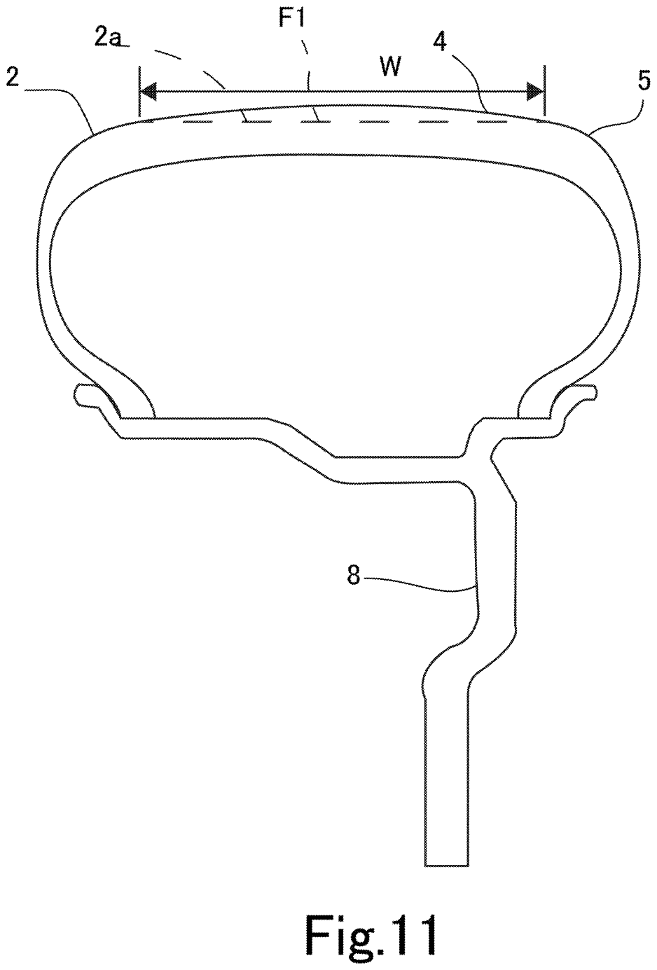

Next, examples of the motor sport tire adjusted by the motor sport tire adjustment device according to the present embodiment are described with reference to FIG. 11 to FIG. 14. In FIG. 11, a cross-sectional shape of the tire 2 before being shaved is illustrated by a solid line, and a surface shape of the tread portion 4 of the tire after being shaved is illustrated by a dashed line as a tread portion shaved surface 2a. To facilitate understanding of the shaved state, the shaving depth (amount) is merely illustrative.

First, as an example, in the motor sport tire adjustment device according to the present embodiment, each of the units is set as follows, and the tire 2 adjusted as illustrated in FIG. 11 is obtained.

The first adjustment mechanism 34 and the second adjustment mechanism 36 position the blade 20 to abut on the tread portion 4 of the tire 2. More specifically, the first adjustment mechanism 34 moves the blade 20 in the first direction toward the tire 2 to an extent that the blade edge 20a can shave the surface of the tread portion 4. The second adjustment mechanism 36 positions the blade 20 at a position facing the tread portion 4 of the tire 2 (for example, the position facing the center region of the tread portion 4). The blade angle adjustment mechanism 38 is in the basic posture at the angle of zero degrees, and adjusts the blade edge line along the blade edge of the blade 20 to an angle parallel to the center axis X2 of the tire 2.

By shaving the tire 2 by the blade 20 set as described above, the tread portion shaved surface 2a (illustrated by a dashed line in FIG. 11) that is the shaved surface extending in a direction parallel to the center axis X2 is formed on the tread portion 4 of the tire 2. The tread portion shaved surface 2a forms a linear portion F1 parallel to the center axis X2 within a range of a relatively wide width W (width in the left-right direction of the tire) on the tread portion 4. The linear portion F1 forms a linear surface portion in a cross-section of the tire as illustrated in FIG. 11. Such a linear portion F1 is flat in the width direction of the tire 2, but forms an outline close to a true circle around the center axis X2 of the tire in an outer peripheral direction of the tire 2. Unlike a polished surface, the tread portion shaved surface 2a has a relatively smooth surface. Further, since the portion of the surface hardened and deteriorated by heat cycle after traveling is shaved, a relatively soft and fresh surface is exposed, and the tire in such an exposed state easily re-exerts the original traveling performance of the tire. Further, the motor sport tire adjustment device 100 can remove dusts and the like adhering to the surface of the tire 2 in circuit traveling. This makes it possible to clean the surface of the tire, and the original traveling performance of the tire is easily exerted in next traveling. The tread portion shaved surface 2a is a surface for traveling, and for example, can increase a ground-contact area with a road surface and can further improve grip performance of the tire during acceleration and deceleration. For example, by forming the tread portion shaved surface 2a on the tread portion, it is possible to obtain the traveling characteristics and the traveling performance in which the tire easily grips the road surface in straight traveling and during acceleration and deceleration. The tread portion shaved surface 2a easily brings out the utmost traveling performance of the tire by the shaved shape in the motor sport.

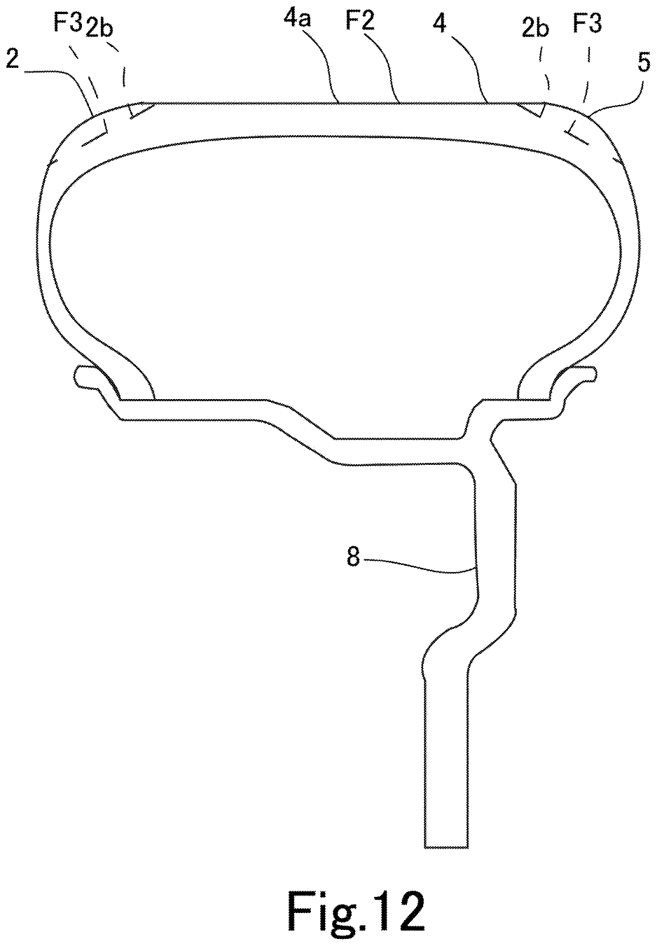

Next, as another example, issues to be solved by adjustment of the tire 2 as illustrated in FIG. 12 by the motor sport tire adjustment device 100 according to the present embodiment are described.

For example, in a case where the motor sport tire adjustment device 100 shaves a center region 4a of the tread portion 4 of the tire up to a relatively deep position so as to form a linear portion F2 as illustrated in FIG. 12, a rubber thickness of the center region 4a of the tread portion 4 is gradually reduced. Along therewith, the shoulder portion 5 is slightly sharpened to form a corner part in some cases.

Such a shoulder portion 5 forms a corner part slightly sharper than the original shoulder portion 5. In a case where such a corner part is positioned on an outside on a side opposite to a turn direction in cornering, an issue may arise that the corner part is caught and drawn between the road surface and the tread portion 4 to generate vibration, which may deteriorate steering performance. Therefore, it is known that, in a case where the center region 4a of the tread portion 4 is shaved, a new issue arises that the corner part of the shoulder portion 5 is easily generated. The new issue that the corner part easily occurs on the shoulder portion 5 arises only because the tread portion 4 is daringly shaved. The present technique provides means for solving such an issue.

In the motor sport tire adjustment device 100 according to the present embodiment, each of the units is set as follows, and the tire 2 that is adjusted to cause the shoulder portion 5 to have a shoulder portion shaved surface 2b as a shaved surface as illustrated in FIG. 12 is obtained.

The blade angle adjustment mechanism 38 adjusts the blade edge line along the blade edge 20a of the blade 20 to an angle inclined relative to the center axis X2 of the tire 2 between the first direction and the second direction. The blade angle adjustment mechanism 38 is inclined to an angle of, for example, +30 degrees or −30 degrees relative to the center axis X2. In other words, the blade 20 is inclined rightward or leftward by, for example, 30 degrees relative to the center axis X2. The first adjustment mechanism 34 and the second adjustment mechanism 36 position the blade 20 to abut on the shoulder portion 5 of the tire 2. More specifically, the second adjustment mechanism 36 positions the blade 20 at a position facing a position where the shoulder portion shaved surface 2b of the shoulder portion 5 is to be formed. Thereafter, the first adjustment mechanism 34 moves the blade 20 in the first direction toward the tire 2 to a position where the blade edge 20a can obliquely shave the surface of the shoulder portion 5.

By shaving the tire 2 by the blade 20 positioned as described above, the shoulder portion shaved surface 2b at a predetermined angle relative to the center axis X2 is formed on the shoulder portion 5 of the tire 2. A linear portion F3 that is inclined by 30 degrees relative to the center axis X2 and has a predetermined width is formed on the shoulder portion shaved surface 2b. Such a linear portion forms an outline close to a true circle relative to the center axis X2 in the outer peripheral direction of the tire 2. Such a shoulder portion shaved surface 2b can prevent the corner part from being formed on the shoulder portion 5, and prevents generation of an issue that the corner part is caught and drawn between the road surface and the tread portion 4 to generate vibration in cornering, and deteriorates steering performance. For example, by forming the shoulder portion shaved surface 2b, it is possible to obtain traveling characteristics and traveling performance for improving steering property and the like in cornering.

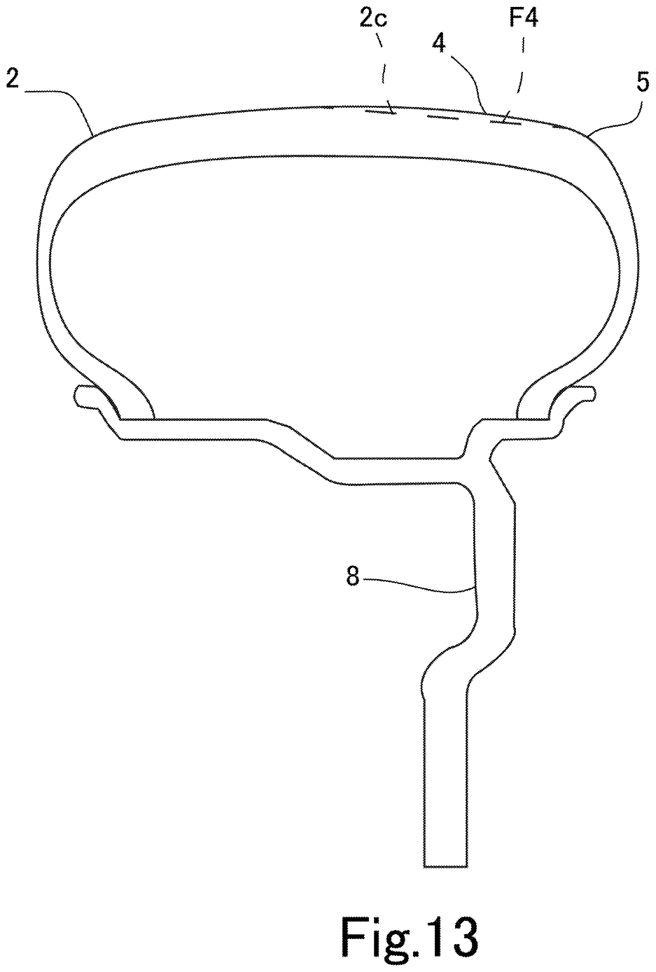

In addition, in the motor sport tire adjustment device according to the present embodiment, each of the units is set as follows, and the tire that is adjusted to cause the tread portion 4 to have a tread portion inclined shaved surface 2c as a shaved surface as illustrated in FIG. 13 is obtained.

The blade angle adjustment mechanism 38 adjusts the blade edge line along the blade edge 20a of the blade 20 to an angle inclined relative to the center axis X2 of the tire between the first direction and the second direction. The blade angle adjustment mechanism 38 is inclined to an angle of, for example, +5 degrees relative to the center axis X2. In other words, the blade 20 is inclined rightward by, for example, five degrees relative to the center axis X2 of the tire. The first adjustment mechanism 34 and the second adjustment mechanism 36 position the blade 20 to abut on the tread portion 4 of the tire 2. More specifically, the second adjustment mechanism 36 positions the blade 20 at a position that faces the tread portion 4 of the tire 2 and is slightly close to the shoulder portion 5 in the tread portion 4. Thereafter, the first adjustment mechanism 34 moves the blade 20 in the first direction toward the tire 2 to an extent that the blade edge 20a can shave the surface of the tread portion 4.

By shaving the tire 2 by the blade 20 set as described above, the tread portion inclined shaved surface 2c at a predetermined angle relative to the center axis X2 is formed on the tread portion 4 of the tire 2. Since a part of the tread portion 4 is shaved, a linear portion F4 that is inclined by, for example, five degrees and has a predetermined width is formed on the tread portion inclined shaved surface 2c as illustrated in FIG. 13. Such a linear portion forms an outline close to a true circle relative to the center axis X2 in the outer peripheral direction of the tire. Therefore, for example, by forming the linear portion F4 corresponding to a camber angle (an angle between the tire and the ground-contact surface), it is possible to increase the ground-contact area with the road surface and to improve grip performance of the tire 2. For example, by forming the tread portion inclined shaved surface 2c on the tread portion, the traveling characteristics and the traveling performance in which the tire more easily grips the road surface in response to the camber angle in straight traveling and during acceleration and deceleration can be obtained. According to the present technique, when the camber angle is adjusted on site, the linear portion corresponding to the camber angle can be formed together on the tread portion 4. Thus, a process in which a tire is carried into a tire adjustment factory once to adjust the camber angle and the like, is adjusted again, and is then carried into the circuit again can be performed in the circuit, which makes it possible to drastically shorten the adjustment process.

Further, since the blade 20 is a straight blade having a predetermined width, the linear portion F4 having the predetermined inclination can be formed in a relatively wide region in the width direction. For example, the linear portion F4 having an inclination angle of 5/100 mm can be formed by the tread portion inclined shaved surface 2c. Such a tread portion inclined shaved surface 2c can be substantially uniformly formed over the entire circumference.

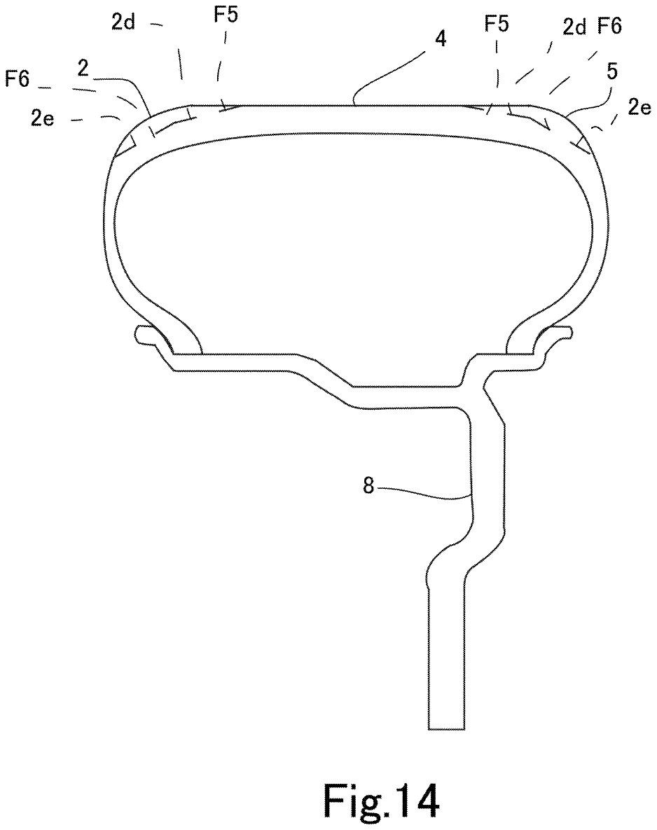

In the motor sport tire adjustment device 100 according to the present embodiment, each of the units is set as follows, and the tire 2 that is adjusted to cause the shoulder portion 5 to have a first shoulder portion shaved surface 2d and a second shoulder portion shaved surface 2e as shaved surfaces as illustrated in FIG. 14 is obtained. For example, as described above, along with shaving of the tread portion 4, the shoulder portion 5 is slightly sharpened to form a corner part in some cases. As means for solving such an issue, the first shoulder portion shaved surface 2d and the second shoulder portion shaved surface 2e are formed on the shoulder portion 5.

In the motor sport tire adjustment device 100 according to the present embodiment, each of the units is set as follows.

For example, to adjust the tire, a series of steps S13 to S18 may be performed a plurality of times while the setting is changed. For example, the shoulder portion 5 may be shaved two times at different angles.

For example, in the second direction adjustment step S15, the second adjustment mechanism 36 positions the blade 20 at a position facing a position of the shoulder portion 5 of the tire 2 where the first shoulder portion shaved surface 2d is to be formed (for example, a position of the shoulder portion 5 on the tread portion 4 side).

Thereafter, in the blade angle adjustment step S16, the blade angle adjustment mechanism 38 adjusts the blade edge line along the blade edge 20a of the blade 20 to an angle inclined relative to the center axis X2 of the tire 2 between the first direction and the second direction. The blade angle adjustment mechanism 38 is inclined to an angle of, for example, +10 degrees or −10 degrees relative to the center axis X2. In other words, the blade 20 is inclined rightward or leftward by, for example, 10 degrees relative to the center axis X2.

Further, in the first direction adjustment step S17, the first adjustment mechanism 34 moves the blade 20 in the first direction toward the tire 2 to a position where the blade edge 20a can obliquely shave the surface of the shoulder portion 5.

In the subsequent tire adjustment step S18, by shaving the tire 2 by the blade 20 positioned as described above, the first shoulder portion shaved surface 2d at a predetermined angle relative to the center axis X2 is formed on the shoulder portion 5 of the tire 2. Since the shoulder portion 5 is shaved as illustrated in FIG. 14, a linear portion F5 that is inclined by 10 degrees and has a predetermined width is formed on the first shoulder portion shaved surface 2d. Such a linear portion F5 forms an outline close to a true circle relative to the center axis X2 in the outer peripheral direction of the tire 2. Therefore, for example, it is possible to prevent the corner part from being formed on the shoulder portion 5, and to prevent generation of an issue that the corner part is caught and drawn between the road surface and the tread portion 4 to generate vibration in cornering, and deteriorates steering performance.

Thereafter, the series of steps S13 to S18 is performed again while the setting is changed.

For example, in the second direction adjustment step S15, the second adjustment mechanism 36 positions the blade 20 at a position facing a position of the shoulder portion 5 of the tire 2 where the second shoulder portion shaved surface 2e is to be formed (for example, an outside position of the shoulder portion 5). The second shoulder portion shaved surface 2e is formed on the outside of the first shoulder portion shaved surface 2d in the width direction.

Thereafter, in the blade angle adjustment step S16, the blade angle adjustment mechanism 38 adjusts the blade edge line along the blade edge 20a of the blade 20 to an angle inclined relative to the center axis X2 of the tire 2 between the first direction and the second direction. The blade angle adjustment mechanism 38 is inclined to an angle of, for example, +30 degrees or −30 degrees relative to the center axis X2. In other words, the blade 20 is inclined rightward or leftward by, for example, 30 degrees relative to the center axis X2.

Further, in the first direction adjustment step S17, the first adjustment mechanism 34 moves the blade 20 in the first direction toward the tire 2 to a position where the blade edge 20a can obliquely shave the surface of the shoulder portion 5. The first adjustment mechanism moves the blade 20 to a position further advanced in the first direction from the position where the first shoulder portion shaved surface 2d is formed.

In the subsequent tire adjustment step S18, by shaving the tire 2 by the blade 20 positioned as described above, the second shoulder portion shaved surface 2e at a predetermined angle to the center axis X2 is formed on the shoulder portion 5 of the tire 2. Since the shoulder portion 5 is shaved as illustrated in FIG. 14, a linear portion F6 that is inclined by 30 degrees and has a predetermined width is formed on the second shoulder portion shaved surface 2e. Such a linear portion F6 forms an outline close to a true circle relative to the center axis X2 in the outer peripheral direction of the tire 2. According to such a mode, for example, it is possible to form the shaved surfaces different in inclination at two stages on the shoulder portion 5, to further prevent the corner part from being formed, and to prevent generation of an issue that the corner part is caught and drawn between the road surface and the tread portion 4 to generate vibration in cornering, and deteriorates steering performance. In addition, when the first shoulder portion shaved surface 2d is formed, the shape of the tire can be set so as to form the surface facilitating ground contact at a relatively shallow corner angle in cornering, and to bring out the predetermined traveling performance. Further, when the second shoulder portion shaved surface 2e is formed, the shape of the tire can be set so as to improve the steering performance and the like at a relatively deep corner angle in cornering, and to bring out the predetermined traveling performance.

As another modification, when the series of steps S13 to S18 is performed a plurality of times while the setting is changed, the shaved surface is formed a plurality of times on the shoulder portion 5, and the final shape of the shoulder portion 5 can be brought close to an arc shape. As a result, the shape of the shoulder portion 5 of the tire can be set so as to prevent the corner part from being formed and to enable smoother traveling in cornering. For example, by forming the first shoulder portion shaved surface 2d and the second shoulder portion shaved surface 2e, the traveling characteristics and the traveling performance in which the tire more easily grips the road surface in response to the corner angle in cornering can be obtained.

According to the embodiment of the present invention configured as described above, the blade 20 is adjusted in inclination by the blade angle adjustment mechanism 38 and is positioned by the first adjustment mechanism 34 and the second adjustment mechanism 36, can shave the surface of the tire 2 in the intended shape, and can adjust the motor sport tire 2 to the shape having desired traveling characteristics. As a result, the motor sport tire 2 can be adjusted to have the desired traveling characteristics while thermal deterioration in the case where the shape of the surface of the tire 2 is adjusted. For example, the tread portion 4 of the tire 2 can be adjusted to form the linear portion parallel to the axial direction of the tire 2, and for example, the ground-contact surface of the tread portion 4 of the tire 2 can be increased. Further, for example, a part of the tread portion 4 of the tire 2 can be adjusted to form the linear portion of the angle slightly inclined from the axial direction of the tire 2, and for example, the linear portion corresponding to the camber angle can be formed on the tread portion 4. Therefore, by shaving the surface of the tire 2, it is possible to adjust the shape of the tire 2 so as to exert the desired traveling characteristics of the tire 2 at an extremely high level while suppressing thermal deterioration of the tire 2 during shaving. Further, for example, the shape of the tire 2 can be relatively easily and freely deformed. Thus, a driver and a team can try by changing the traveling characteristics of the tire 2, and can easily reach better setting for bringing out the original performance of the tire to the utmost limit based on characteristics and a condition of the driver. Therefore, for example, according to the embodiment of the present invention, by shaving the surface of the tire 2, it is possible to actively change and adjust the shapes of the tread portion 4 and the shoulder portion 5 of the tire 2, and to perform setting or adjustment of the tire including change of the shape of the motor sport tire.

According to the embodiment of the present invention configured as described above, the shaved surface extending in the direction parallel to the center axis X2 is formed on the tread portion 4 of the tire 2 by the blade 20. As a result, the traveling surface for improving ground contact can be easily formed on the tread portion 4 of the tire 2 while thermal deterioration of the surface of the tire 2 during shaving is suppressed. Further, since the blade 20 positioned by the first adjustment mechanism 34 and the second adjustment mechanism 36 abuts on the rotating tire 2, the traveling surface of the tire 2 can be easily brought into close to a circle having a predetermined diameter. As a result, it is possible to shave the surface of the tire 2 in the intended shape, and to adjust the motor sport tire 2 to the shape having the desired traveling characteristics. For example, the tread portion 4 of the tire 2 can be adjusted to form the linear portion parallel to the axial direction of the tire 2, the ground-contact surface of the tire 2 can be easily increased, and the traveling performance can be improved. Therefore, by shaving the surface of the tire 2, it is possible to adjust the shape of the tire 2 so as to exert the desired traveling characteristics of the tire 2 at a higher level while suppressing thermal deterioration of the tire 2 during shaving.

According to the embodiment of the present invention configured as described above, the blade angle adjustment mechanism 38 adjusts the blade edge line along the blade edge 20a of the blade 20 to the angle inclined relative to the center axis X2 of the tire 2 between the first direction and the second direction. In addition, the first adjustment mechanism 34 and the second adjustment mechanism 36 position the blade 20 to abut on the tread portion 4 of the tire 2. The shaved surface at the predetermined angle relative to the center axis X2 is formed on the tread portion 4 of the tire 2 by the blade 20. As a result, it is possible to form the shaved surface at the predetermined angle on the tread portion 4 of the tire 2 and to adjust the traveling performance of the tire 2 at a higher level while suppressing thermal deterioration of the surface of the tire 2 during shaving. For example, the shaved surface of the linear portion corresponding to the camber angle is formed on the tread portion 4, which makes it possible to further increase the ground-contact area of the tire 2 with the road surface, and to further improve the grip performance of the tire 2. Therefore, the shape of the tire 2 can be adjusted so as to exert the desired traveling characteristics of the tire 2 at a higher level.

According to the embodiment of the present invention configured as described above, the blade angle adjustment mechanism 38 adjusts the blade edge line along the blade edge 20a of the blade 20 to the angle inclined relative to the center axis X2 of the tire 2 between the first direction and the second direction. In addition, the first adjustment mechanism 34 and the second adjustment mechanism 36 position the blade 20 to abut on the shoulder portion 5 of the tire 2. The shaved surface at the predetermined angle relative to the center axis X2 is formed on the shoulder portion 5 of the tire 2 by the blade 20. As a result, it is possible to form the shaved surface at the predetermined angle on the shoulder portion 5 of the tire 2 and to adjust the traveling performance of the tire 2 at a higher level while suppressing thermal deterioration of the surface of the tire 2 during shaving. For example, in a case where the curve of the shoulder portion 5 of the tire 2 is relatively sharp due to shaving of the tread portion 4 of the tire 2, the shoulder portion 5 causes vibration and deterioration in steering performance by being caught (drawn) to the traveling surface in cornering. By forming the shaved surface at the predetermined angle on the shoulder portion 5, it is possible to suppress such vibration and deterioration in traveling performance. Therefore, the shape of the tire 2 can be adjusted so as to suppress deterioration of the traveling performance of the tire 2 in cornering, and to exert the desired traveling characteristics of the tire 2 at a higher level.

According to the embodiment of the present invention configured as described above, the blade angle adjustment mechanism 38 is configured to adjust the inclination of the blade 20 to the angle within the range from −40 degrees to +40 degrees relative to the center axis X2 of the tire 2 on the horizontal plane. Therefore, the shaved surface at the predetermined angle relative to the center axis X2 can be formed on the tread portion 4, or the shaved surface at the predetermined angle relative to the center axis X2 can be formed on the shoulder portion 5. Thus, by shaving the surface of the tire 2 by one device, the shape of the tire 2 can be easily adjusted so as to exert the desired traveling characteristics of the tire 2 at an extremely high level while thermal deterioration of the tire 2 during shaving is suppressed.

After sport traveling in a motor sport (for example, the temperature of the tire 2 is relatively high until about one day after high-speed traveling in sports) or in a case where an external temperature is high and the temperature of the tire 2 is relatively high, when the whole of the blade edge of the blade 20 having a predetermined width (for example, a width of about 80 mm) is caused to abut on the surface of the tire 2 to shave the tire 2 up to the depth of, for example, 0.5 mm or more, the rubber cannot bear the load, and an issue may arise that the rubber softly tears like a so-called string cheese and a tear opening may be widened. With regard to such an issue, according to the embodiment of the present invention, the motor sport tire adjustment device 100 further includes the third adjustment mechanism that is configured to obliquely incline the blade 20 in the up-down direction. This makes it possible to suppress a load by resistance to the surface of the tire 2 during shaving, and to prevent the surface of the tire 2 from tearing. Further, even in the case where the blade 20 is obliquely inclined in the up-down direction, the blade 20 can still easily form the linear portion on the surface of the tire 2 in the width direction of the tire 2. Thus, such a configuration makes it possible to achieve improvement in both efficiency and reliability of shaving of the tire 2.

According to the embodiment of the present invention configured as described above, the structure 16 on which the first adjustment mechanism 34, the second adjustment mechanism 36, and the blade angle adjustment mechanism 38 are placed, and the movable wheels 18 that enable movement of the structure 16 are provided. The weight in the state where the tire 2 is not held is within the range from about 70 kg to about 200 kg. Therefore, the motor sport tire 2 adjustment device can be easily carried into the circuit and the like by about two to four adults, the surface of the tire 2 can be shaved in the intended shape on site, and the motor sport tire 2 can be adjusted to the shape having the desired traveling characteristics. Accordingly, as compared with a case where the tire 2 is brought back to and adjusted in the factory, adjustment easiness and efficiency of the motor sport tire 2 can be drastically improved.

According to the embodiment of the present invention configured as described above, the motor sport tire adjustment device 100 further includes the liquid reservoir portion 62 reserving the liquid, and the liquid reservoir portion 62 is disposed such that the lower part of the tire 2 is immersed in the liquid. As a result, the tire 2 can be cooled and easily shaved by the blade 20, and for example, the components of the liquid enable the edge of the blade 20 to smoothly shave the tire 2. Accordingly, the motor sport tire 2 can be adjusted to the shape having the desired traveling characteristics with higher accuracy.

According to the embodiment of the present invention configured as described above, the blade 20 that is adjusted in inclination in the blade angle adjustment step S16 and is positioned in the first direction adjustment step S17 and the second direction adjustment step S15 can shave the surface of the tire 2 in the intended shape, and can adjust the motor sport tire 2 to the shape having the desired traveling characteristics. Accordingly, the motor sport tire 2 can be adjusted to have the desired traveling characteristics while thermal deterioration in the case of adjusting the surface shape of the tire 2 is suppressed. For example, the tread portion 4 of the tire 2 can be adjusted to form the linear portion parallel to the axial direction of the tire 2, and for example, the ground-contact surface of the tread portion 4 of the tire 2 can be increased. Further, for example, a part of the tread portion 4 of the tire 2 can be adjusted to form the linear portion of the angle slightly inclined from the axial direction of the tire 2, and for example, the linear portion corresponding to the camber angle can be formed on the tread portion 4. Therefore, by shaving the surface of the tire 2, it is possible to adjust the shape of the tire 2 so as to exert the desired traveling characteristics of the tire 2 at an extremely high level while suppressing thermal deterioration of the tire 2 during shaving. Further, for example, the shape of the tire 2 can be relatively easily and freely deformed. Thus, a driver and a team can try by changing the traveling characteristics of the tire 2, and can easily reach better setting for bringing out the original performance of the tire 2 to the utmost limit based on characteristics and a condition of the driver.

### Technique 1

A motor sport tire adjustment device for adjusting a motor sport tire, the motor sport tire adjustment device including:
a blade configured to shave a surface of the tire;
a blade attachment portion to which the blade is attached;
a blade rotation driving unit configured to rotate the blade attachment portion;
a tire holding unit configured to hold the tire;
a tire rotation driving unit configured to rotate the tire in a state where the tire is held;
a first adjustment mechanism configured to be able to move the blade in a first direction toward the tire;
a second adjustment mechanism configured to be able to move the blade in a second direction orthogonal to the first direction; and
a blade angle adjustment mechanism configured to be able to adjust inclination of the blade between the first direction and the second direction, in which
the blade is adjusted in inclination by the blade angle adjustment mechanism and is positioned by the first adjustment mechanism and the second adjustment mechanism, and the blade shaves the surface of the tire in an intended shape and adjusts the motor sport tire to a shape having desired traveling characteristics.

### Technique 2

The motor sport tire adjustment device according to technique 1, in which
the blade angle adjustment mechanism adjusts a blade edge of the blade to an angle parallel to a center axis of the tire,
the first adjustment mechanism and the second adjustment mechanism position the blade to abut on a tread portion of the tire, and
a shaved surface extending in a direction parallel to the center axis is formed on the tread portion of the tire by the blade.

### Technique 3

The motor sport tire adjustment device according to technique 1, in which
the blade angle adjustment mechanism adjusts a blade edge line along a blade edge of the blade to an angle inclined relative to a center axis of the tire between the first direction and the second direction,
the first adjustment mechanism and the second adjustment mechanism position the blade to abut on a tread portion of the tire, and
a shaved surface at a predetermined angle relative to the center axis is formed on the tread portion of the tire by the blade.

### Technique 4

The motor sport tire adjustment device according to technique 1, in which
the blade angle adjustment mechanism adjusts a blade edge of the blade to an angle inclined relative to a center axis of the tire between the first direction and the second direction,
the first adjustment mechanism and the second adjustment mechanism position the blade to abut on a shoulder portion of the tire, and
a shaved surface at a predetermined angle relative to the center axis is formed on the shoulder portion of the tire by the blade.

### Technique 5

The motor sport tire adjustment device according to technique 1, in which the blade angle adjustment mechanism is configured to adjust the inclination of the blade to an angle in a range from −40 degrees to +40 degrees relative to a center axis of the tire on a horizontal plane.

### Technique 6

The motor sport tire adjustment device according to technique 1, further including a third adjustment mechanism configured to obliquely incline the blade in an up-down direction.

### Technique 7

The motor sport tire adjustment device according to technique 1, further including:
a structure on which the first adjustment mechanism, the second adjustment mechanism, and the blade angle adjustment mechanism are placed; and
a movable portion configured to enable movement of the structure, in which
a weight in a state where the tire is not held is a weight in a range from about 70 kg to about 200 kg.

### Technique 8

The motor sport tire adjustment device according to any one of techniques 1 to 7, further including a liquid reservoir portion configured to reserve liquid, the liquid reservoir portion being disposed to cause a lower part of the tire to be immersed in the liquid.

### Technique 9

A motor sport tire adjustment method of adjusting a motor sport tire, the motor sport tire adjustment method including: a tire rotation step of rotating the tire in a state where the tire is held; a blade rotation step of rotating a blade attachment portion to which a blade is attached; a second direction adjustment step of moving, by a second adjustment mechanism, the blade in a second direction orthogonal to a first direction toward the tire; a blade angle adjustment step of adjusting, by a blade angle adjustment mechanism, inclination of the blade between the first direction and the second direction; a first direction adjustment step of moving, by a first adjustment mechanism, the blade in the first direction; and a tire adjustment step of shaving a surface of the tire in an intended shape and adjusting the motor sport tire to a shape having desired traveling characteristics by the blade that is adjusted in inclination in the blade angle adjustment step and is positioned in the first direction adjustment step and the second direction adjustment step.

The embodiments of the present invention are not limited to the above-described embodiments, and other modifications can be applied. The motor sport tire adjustment device 100 may further include the third adjustment mechanism that is configured to obliquely incline the blade 20 in the up-down direction. The third adjustment mechanism is a mechanism that can change the heights of the supporting parts for the right-side portion and the left-side portion of the blade attachment portion 22. Therefore, for example, in the state where the blade 20 is attached to the blade attachment portion 22, the blade edge line along the blade edge 20a is inclined at the angle within the range from +45 degrees to −45 degrees relative to the center axis X2 in the tangential direction of the tire from the state parallel to the center axis X2. For example, the blade edge 20a is disposed with inclination of about five degrees such that the right side of the blade edge 20a is positioned slightly above the left side. The blade is disposed to be obliquely downward from the right side to the left side of the tread portion 4 of the tire. After traveling in a motor sport (for example, the temperature of the tire is relatively high until about one day after high-speed traveling) or in a case where an external temperature is high and the temperature of the tire is relatively high, when the whole of the blade 20 having the predetermined width (for example, a width of about 80 mm) is caused to abut on the surface of the tire to shave the tire up to the depth of, for example, 0.5 mm or more, the rubber cannot bear the load, and an issue may arise that the rubber softly tears like a so-called string cheese and a tear opening is widened. With regard to such an issue, when the blade edge 20a of the blade is obliquely inclined on the plane (for example, the second virtual plane E2) in the vertical direction relative to the center axis X2 (for example, the blade 20 and the blade attachment portion 22 are inclined), the load by resistance to the surface of the tire can be suppressed, and the surface of the tire can be prevented from tearing. Further, since the blade 20 is slightly inclined in the up-down direction, the blade 20 can still easily form the plane on the surface of the tire. Thus, such a configuration makes it possible to achieve improvement in both efficiency and reliability of shaving of the tire.

What is claimed is:

1. A tire shaving device for shaving a surface of a tire, the tire shaving device comprising:
a blade configured to shave the surface of the tire;
a blade attachment portion to which the blade is attached;
a blade rotation driving unit configured to rotate the blade attachment portion;
a tire holding unit configured to hold the tire;
a tire rotation driving unit configured to rotate the tire in a state where the tire is held; and
a positioning unit configured to be able to position the blade at a predetermined distance from a center axis of the tire, wherein
the tire shaving device shaves the surface of the tire to form a traveling surface of the tire at the predetermined distance from the center axis of the tire while suppressing thermal deterioration of the surface of the tire during shaving.

2. The tire shaving device according to claim 1, wherein a blade edge line along a blade edge of the blade is disposed on a second virtual plane parallel to a first virtual plane passing through the center axis of the tire.

3. The tire shaving device according to claim 2, wherein the blade edge line along the blade edge of the blade is inclined at an angle in a range from +45 degrees to −45 degrees in a tangential direction of the tire from a state parallel to the center axis of the tire.

4. The tire shaving device according to claim 2, wherein the blade edge of the blade extends in a direction parallel to the center axis of the tire.

5. The tire shaving device according to claim 2, wherein an angle of the blade edge of the blade is an angle in a range from 30 degrees to 60 degrees.

6. The tire shaving device according to claim 5, wherein a rotational speed of the blade attachment portion rotated by the blade rotation driving unit is a rotational speed in a range from 1000 rpm to 8000 rpm.

7. The tire shaving device according to claim 5, wherein a rotational speed of the blade attachment portion rotated by the blade rotation driving unit is larger than a rotational speed of the tire rotated by the tire rotation driving unit.

8. The tire shaving device according to claim 5, wherein a peripheral speed of the blade attached to the blade attachment portion is a value in a range from 150 m/min to 1300 m/min.

9. The tire shaving device according to any one of claims 1 to 8, further comprising a liquid reservoir portion configured to reserve liquid, the liquid reservoir portion being disposed to cause a lower part of the tire to be immersed in the liquid.

10. A tire shaving method of shaving a surface of a tire, the tire shaving method comprising:
a blade rotation step of rotating a blade attachment portion to which a blade is attached;
a tire rotation step of rotating the tire in a state where the tire is held;
a positioning step of positioning the blade at a predetermined distance from a center axis of the tire; and
a tire shaving step of shaving the surface of the tire to form a traveling surface of the tire at the predetermined distance from the center axis of the tire while suppressing thermal deterioration of the surface of the tire during shaving.

11. A motor sport tire adjustment device for adjusting a motor sport tire, the motor sport tire adjustment device comprising:
a blade configured to shave a surface of the tire;
a blade attachment portion to which the blade is attached;
a blade rotation driving unit configured to rotate the blade attachment portion;
a tire holding unit configured to hold the tire;
a tire rotation driving unit configured to rotate the tire in a state where the tire is held;
a first adjustment mechanism configured to be able to move the blade in a first direction toward the tire;
a second adjustment mechanism configured to be able to move the blade in a second direction orthogonal to the first direction; and
a blade angle adjustment mechanism configured to be able to adjust inclination of the blade between the first direction and the second direction, wherein
the blade is adjusted in inclination by the blade angle adjustment mechanism and is positioned by the first adjustment mechanism and the second adjustment mechanism, and the blade shaves the surface of the tire in an intended shape and adjusts the motor sport tire to a shape having desired traveling characteristics.

12. The motor sport tire adjustment device according to claim 11, wherein
the blade angle adjustment mechanism adjusts a blade edge of the blade to an angle parallel to a center axis of the tire,
the first adjustment mechanism and the second adjustment mechanism position the blade to abut on a tread portion of the tire, and
a shaved surface extending in a direction parallel to the center axis is formed on the tread portion of the tire by the blade.

13. The motor sport tire adjustment device according to claim 11, wherein
the blade angle adjustment mechanism adjusts a blade edge line along a blade edge of the blade to an angle inclined relative to a center axis of the tire between the first direction and the second direction,
the first adjustment mechanism and the second adjustment mechanism position the blade to abut on a tread portion of the tire, and
a shaved surface at a predetermined angle relative to the center axis is formed on the tread portion of the tire by the blade.

14. The motor sport tire adjustment device according to claim 11, wherein
the blade angle adjustment mechanism adjusts a blade edge of the blade to an angle inclined relative to a center axis of the tire between the first direction and the second direction,
the first adjustment mechanism and the second adjustment mechanism position the blade to abut on a shoulder portion of the tire, and
a shaved surface at a predetermined angle relative to the center axis is formed on the shoulder portion of the tire by the blade.

15. The motor sport tire adjustment device according to claim 11, wherein the blade angle adjustment mechanism is configured to adjust the inclination of the blade to an angle in a range from −40 degrees to +40 degrees relative to a center axis of the tire on a horizontal plane.

16. The motor sport tire adjustment device according to claim 11, further comprising a third adjustment mechanism configured to obliquely incline the blade in an up-down direction.

17. The motor sport tire adjustment device according to claim 11, further comprising:
a structure on which the first adjustment mechanism, the second adjustment mechanism, and the blade angle adjustment mechanism are placed; and
a movable portion configured to enable movement of the structure, wherein
a weight in a state where the tire is not held is a weight in a range from about 70 kg to about 200 kg.

18. The motor sport tire adjustment device according to any one of claims 11 to 17, further comprising a liquid reservoir portion configured to reserve liquid, the liquid reservoir portion being disposed to cause a lower part of the tire to be immersed in the liquid.
